(19) United States
(12) Patent Application Publication
(10) Pub. No.: US 2023/0052499 A1
(43) Pub. Date: Feb. 16, 2023

(54) SECONDARY BATTERY, METHOD FOR MANUFACTURING POSITIVE ELECTRODE ACTIVE MATERIAL, PORTABLE INFORMATION TERMINAL, AND VEHICLE

(71) Applicant: SEMICONDUCTOR ENERGY LABORATORY CO., LTD., ATSUGI-SHI, KANAGAWA-KEN (JP)

(72) Inventors: Yoshihiro KOMATSU, Ebina, Kanagawa (JP); Shiori SAGA, Atsugi, Kanagawa (JP); Yohei MOMMA, Isehara, Kanagawa (JP); Hiroshi KADOMA, Sagamihara, Kanagawa (JP); Toshikazu OHNO, Atsugi, Kanagawa (JP); Shunpei YAMAZAKI, Setagaya, Tokyo (JP)

(21) Appl. No.: 17/778,538

(22) PCT Filed: Nov. 16, 2020
(86) PCT No.: PCT/IB2020/060735

§ 371 Date: May 20, 2022

(30) Foreign Application Priority Data
Nov. 28, 2019 (JP) 2019-215033
Dec. 4, 2019 (JP) 2019-219266
Dec. 6, 2019 (JP) 2019-221403

(51) Int. Cl. H01M 4/525; H01M 4/04; C01G 53/00

(52) U.S. Cl. CPC H01M 4/525; H01M 4/0471; C01G 53/006; H01M 2220/20; H01M 2004/028

(57) ABSTRACT

Secondary batteries using lithium cobalt oxide as positive electrode active materials have a problem of a decrease in battery capacity due to repeated charging/discharging, for example. A positive electrode active material particle which hardly deteriorates is provided. In a first step, a container in which a lithium oxide and a fluoride are set is placed in a heating furnace, and in a second step, the inside of the heating furnace is heated in an atmosphere containing oxygen. The heating temperature of the second step is from 750° C. to 950° C., inclusive. By the manufacturing method, fluorine can be contained in the positive electrode active material particle to increase the wettability of the surface of the positive electrode active material so that the surface of the positive electrode active material is homogenized and planarized. The crystal structure of the thus manufactured positive electrode active material is unlikely to be broken in repeated high-voltage charging/discharging. Thus, secondary batteries using the positive electrode active material having such a feature have greatly improved cycle characteristics.

### TECHNICAL FIELD

One embodiment of the present invention relates to a secondary battery using a positive electrode active material and a manufacturing method thereof.

One embodiment of the present invention relates to an object, a method, or a manufacturing method. The present invention relates to a process, a machine, manufacture, or a composition (composition of matter). One embodiment of the present invention relates to a semiconductor device, a display device, a light-emitting device, a power storage device, a lighting device, an electronic device, or a manufacturing method thereof.

Note that electronic devices in this specification generally mean devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HEV), electric vehicles (EV), and plug-in hybrid electric vehicles (PHEV), and the like, and the lithium-ion secondary batteries are essential as rechargeable energy supply sources for today's information society.

Thus, improvement of a positive electrode active material has been studied to increase the cycle performance and the capacity of the lithium-ion secondary battery (Patent Document 1).

The performances required for power storage devices are safe operation and longer-term reliability under various environments, for example.

On the other hand, fluorides such as fluorite (calcium fluoride) have been used as flux in iron making and the like for a long time and the physical properties thereof have been studied (see Non-Patent Document 1).

### REFERENCE

### Patent Document

[Patent Document 1] Japanese Published Patent Application No. 2019-21456

### Non-Patent Document

### [Non-Patent Document 1]

W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36[1] 12-17 (1953).

### SUMMARY OF THE INVENTION

### Problems to be Solved by the Invention

Lithium-ion secondary batteries and positive electrode active materials used therein need various improvements in capacity, cycle characteristics, charge and discharge characteristics, reliability, safety, cost, and the like.

A material with a layered rock-salt crystal structure, such as lithium cobalt oxide (LiCoO₂), is known to have a high discharge capacity and excel as a positive electrode active material of a secondary battery.

Secondary batteries using lithium cobalt oxide as positive electrode active materials have a problem of a decrease in battery capacity due to repeated charging and discharging or the like.

In view of the above, an object of one embodiment of the present invention is to provide a positive electrode active material particle with little deterioration. Another object of one embodiment of the present invention is to provide a novel positive electrode active material particle. Another object of one embodiment of the present invention is to provide a power storage device with little deterioration. Another object of one embodiment of the present invention is to provide a highly safe power storage device. Another object of one embodiment of the present invention is to provide a novel power storage device.

Another object of one embodiment of the present invention is to provide a novel material, novel active material particles, a novel power storage device, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

In order to achieve at least one of the above objects, a manufacturing method of a positive electrode active material disclosed in this specification includes a first step of placing, in a heating furnace, a container in which a lithium oxide and a fluoride are set and a second step of heating the inside of the heating furnace in an atmosphere containing oxygen, and the heating temperature of the second step is higher than or equal to 750° C. and lower than or equal to 950° C.

In the above method, the heating temperature is preferably higher than or equal to 775° C. and lower than or equal to 925° C. The heating temperature is further preferably higher than or equal to 800° C. and lower than or equal to 900° C.

Preferably, the above method includes a step of putting a lid on the container before the heating or during the heating, and the fluoride is a lithium fluoride.

By the above manufacturing method, fluorine can be contained in the positive electrode active material particle, and fluorine can increase the wettability of the surface of the positive electrode active material so that the surface of the positive electrode active material is homogenized and planarized. The crystal structure of the thus obtained positive electrode active material is unlikely to be broken in repeated high-voltage charging/discharging. Thus, secondary batteries using the positive electrode active material having such a feature have greatly improved cycle characteristics.

In order to achieve at least one of the above objects, another manufacturing method of a positive electrode active material disclosed in this specification includes a first step of forming a lithium oxide by performing first heating on a lithium source and a transition metal source, a second step of placing, in a heating furnace, a container in which a lithium oxide and a fluoride are set, and a third step of performing second heating on the inside of the heating furnace in an atmosphere containing oxygen, and the second heating is performed at higher than or equal to 750° C. lower than or equal to 950° C. and the first heating is performed at a higher temperature than the second heating.

By the above manufacturing method, the surface modification of the positive electrode active material can be performed by a fluoride or the like in the second heating, after forming a layered rock-salt crystal structure with few defects and distortions by the first heating.

The composite oxide containing lithium, a transition metal, and oxygen preferably has a layered rock-salt crystal structure with few defects and distortions. Therefore, the composite oxide is preferably a composite oxide with few impurities. In the case where the composite oxide containing lithium, a transition metal, and oxygen includes a large amount of impurities, the crystal structure is highly likely to have a large number of defects or distortions.

The surface modification of the positive electrode active material is preferably performed by heating with the lid on the container after the fluoride is mixed, so that an impurity cannot be contained. The timing for putting the lid may be any one of the following: the lid is put to cover the container before heating and the container is placed in the heating furnace; the container is placed in the heating furnace and then the lid is put to cover the container; and the lid is put during the heating before the fluoride is melted.

In the above manufacturing method, the step of increasing the concentration of oxygen in the heating furnace may be included before the second step. For example, after the lid is put on the container, the inside of the heating furnace is set to be an oxygen atmosphere.

In order to achieve at least one of the above objects, the roughness of unevenness in a surface of a positive electrode active material particle is set in a particular range to increase the intensity of the vicinity of the surface, whereby a positive electrode active material with few deteriorations can be provided. The surface of the active material particle is preferably slick or shiny almost without cracks or protrusions when observed with a SEM image. Fluorine is important so that unevenness is not caused on the surface, which leads to the regular formation of bonds in the surface. Positive electrode active material particles are formed, for example, in such a manner that a lithium oxide and a fluoride are mixed and heated. In the heating, solid-phase diffusion is promoted due to the presence of fluorine, which reduces cracks or steps and crystal defects such as grain boundaries in the active material particles.

When a portion where pure LiCoO₂ is exposed is present on the surface of the positive electrode active material, unevenness is generated and cobalt or oxygen is released in charging and discharging, which results in breakage of the crystal structure and deterioration. A compound containing magnesium preferably covers evenly the surface so that the exposed portion of pure LiCoO₂ cannot be exposed on the surface. Magnesium has a function of maintaining the crystal structure (layered rock-salt crystal structure) even when Li is deintercalated in discharging. One feature is that magnesium (or fluorine) is present within the vicinity of the surface of the positive electrode active material particle.

Specifically, the positive electrode active material has a root mean square surface roughness (RMS) of less than 3 nm, preferably less than 1 nm, more preferably less than 0.5 nm, when the particle surface unevenness information in the vicinity of the surface is quantified with measurement data in a cross-sectional image taken toward the particle center by a scanning transmission electron microscopy (STEM) observation.

The above structure hardly generates cracks when a pressure is applied to a positive electrode including a positive electrode active material, and thus can maintain the particle shape, in manufacturing of secondary batteries. Unnecessary cracks can be reduced and further the electrode density can be increased.

In the case where the surface has unevenness beyond the above range and is rough, cracks or a breakage of the crystal structure might be generated physically. When the breakage of the crystal structure is caused, the exposed portion of pure LiCoO₂ is exposed on the surface, which might lead to acceleration of deterioration.

Moreover, when a positive electrode active material is manufactured, the surface modification is performed by heating with a lid on. The surface modification facilitates the positive electrode active material to have the above structure, that is, the RMS is less than 3 nm, preferably less than 1 nm, more preferably less than 0.5 nm. Fluorine or fluoride is not diffused to the outside in the annealing with a lid on, and coats the surfaces of other positive electrode active material particles, thereby increasing the wettability with impurities to offer homogenization and planarization.

A preferred example of lithium oxide is a material with a layered rock-salt crystal structure, specifically, a composite oxide represented by LiMO₂. As an example of the element M, one or more elements selected from Co and Ni can be given. As another example of the element M, in addition to one or more elements selected from Co and Ni, one or more elements selected from Al and Mg can be given.

Containing fluorine in the vicinity of the surface enables magnesium, aluminum, or nickel to be present at high concentrations in the vicinity of the surface, in addition to the fluorine. The annealing with a lid on inhibits fluorine from diffusing as a gas to the outside and other substances such as aluminum diffuse into a solid. Fluorine increases the wettability of the surface of the positive electrode active material, so that the surface of the positive electrode active material is homogenized and planarized.

Another embodiment of the present invention is a secondary battery including a positive electrode active material for a positive electrode. With STEM observation of the positive electrode active material, in a section cut toward a center of a particle of a lithium oxide containing fluorine, at least part of the particle has a surface roughness less than 3 nm, when a particle surface unevenness information in the vicinity of the surface is quantified with measurement data.

In the above, the surface roughness is preferably a root mean square surface roughness (RMS) in which a standard deviation is calculated.

In the above, the positive electrode active material preferably has a surface roughness in at least 400 nm of a periphery of the particle.

Another embodiment of the present invention is a portable information terminal including the above secondary battery.

Another embodiment of the present invention is a vehicle including the above secondary battery.

### Effect of the Invention

According to one embodiment of the present invention, a positive electrode active material particle with less deterioration can be provided. According to another embodiment of the present invention, a novel positive electrode active material particle can be provided. According to another embodiment of the present invention, a power storage device with less deterioration can be provided. According to another embodiment of the present invention, a highly safe power storage device can be provided. According to another embodiment of the present invention, a novel power storage device can be provided.

Another embodiment of the present invention can provide a novel material, novel active material particles, a novel power storage device, or a manufacturing method thereof.

Note that the description of these effects does not preclude the existence of other effects. One embodiment of the present invention does not have to have all of these effects. Other effects will be apparent from the descriptions of the specification, the drawings, the claims, and the like, and other effects can be derived from the descriptions of the specification, the drawings, the claims, and the like.

### BRIEF DESCRIPTION OF THE DRAWINGS

FIG. 1 is a phase diagram showing a relation of composition of lithium fluoride and fluoride magnesium and temperature.

FIG. 2 is a graph of DSC analysis results.

FIG. 3 is a graph showing the weight decrease rate when a fluoride is heated.

FIG. 4 is an example of a flowchart illustrating one embodiment of the present invention.

FIG. 5 is an example of a process cross-sectional view illustrating one embodiment of the present invention.

FIG. 6A is a STEM image of an active material particle of one embodiment of the present invention, and FIG. 6B is a STEM image showing a comparative example.

FIG. 7A is a STEM image of the active material particle of one embodiment of the present invention, and FIG. 7B is a STEM image showing the comparative example.

FIG. 8A is a STEM image of the active material particle of one embodiment of the present invention, FIG. 8B is an image obtained by enlarging part of the image of FIG. 8A and trimming the image, FIG. 8C is image data subjected to binarization, FIG. 8D is image data in which a boundary is detected, FIG. 8E is a graph in which coordinate data obtained from the detected boundary are plotted, and FIG. 8F is a graph of only an extracted roughness component by removing a slope and undulation.

FIG. 9A is a STEM image of the active material particle of the comparative example, FIG. 9B is an image obtained by enlarging part of the image of FIG. 9A and trimming the image, and FIG. 9C is a graph of only an extracted roughness component.

FIG. 10A illustrates Condition 1, FIG. 10B illustrates Condition 2, FIG. 10C illustrates Condition 3, and FIG. 10D illustrates a comparative example.

FIG. 11 shows cycle performance of secondary batteries.

FIG. 12A is a STEM image of a particle obtained under Condition 1, FIG. 12B is a STEM image of a particle obtained under Condition 2, and FIG. 12C is a STEM image of a particle obtained under Condition 3.

FIG. 13A is a graph showing an EDX result of the particle obtained under Condition 1, FIG. 13B is a graph showing an EDX result of the particle obtained under Condition 2, and FIG. 13C is a graph showing an EDX result of the particle obtained under Condition 3.

FIG. 14 illustrates a crystal structure and magnetism of a positive electrode active material.

FIG. 15 illustrates a crystal structure and magnetism of a conventional positive electrode active material.

FIG. 16A and FIG. 16B are cross-sectional views of an active material layer containing a graphene compound as a conductive additive.

FIG. 17A and FIG. 17B are diagrams each illustrating an example of a secondary battery.

FIG. 18A, FIG. 18B, FIG. 18C, FIG. 18D, and FIG. 18E are diagrams illustrating structures of secondary batteries.

FIG. 19A is a perspective view of the secondary battery, and FIG. 19B is a cross-sectional perspective view of the secondary battery, and FIG. 19C is a schematic cross-sectional view at the time of charging.

FIG. 20A is a perspective view of a secondary battery, FIG. 20 B is a cross-sectional perspective view of the secondary battery, and FIG. 20C is a perspective view of a battery pack including a plurality of secondary batteries, and FIG. 20D is a top view of the battery pack.

FIG. 21A and FIG. 21B are diagrams illustrating an example of a secondary battery.

FIG. 22A and FIG. 22B are diagrams illustrating a laminated secondary battery.

FIG. 23A, FIG. 23B, FIG. 23C, FIG. 23D, and FIG. 23E are perspective views of electronic devices.

FIG. 24A is a STEM image of the particle obtained in the comparative example and FIG. 24B is a graph of an EDX result in the comparative example.

FIG. 25A and FIG. 25B are graphs showing discharge characteristics of positive electrode active materials formed in Example 1.

FIG. 26 is a graph showing rate characteristics of the positive electrode active materials formed in Example 1.

FIG. 27A and FIG. 27B are graphs showing cycle characteristics of the positive electrode active materials formed in Example 1.

FIG. 28A and FIG. 28B are graphs showing cycle characteristics of the positive electrode active materials formed in Example 1.

FIG. 29A and FIG. 29B are graphs showing cycle characteristics of the positive electrode active materials formed in Example 1.

FIG. 30 is a graph showing cycle characteristics of the positive electrode active materials formed in Example 1.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In this specification and the like, homogenization refers to a phenomenon in which a phenomenon in which, in a solid made of a plurality of elements (e.g., A, B, and C), a certain element (e.g., A) is distributed with similar nature in specific regions. Note that it is acceptable for the specific regions to have substantially the same concentration of the element. For example, a difference in the concentration of the element between the specific regions can be 10% or less. Examples of the specific regions include a surface, a protrusion, a depression, and an inner portion.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, charging refers to transfer of electrons from a positive electrode to a negative electrode in an external circuit. For a positive electrode active material, extraction of lithium ions is called charging. Moreover, a positive electrode active material with a charge depth of greater than or equal to 0.74 and less than or equal to 0.9, more specifically, a charge depth of greater than or equal to 0.8 and less than or equal to 0.83 is referred to as a high-voltage charged positive electrode active material. Thus, for example, LiCoO₂ charged to 219.2 mAh/g is a high-voltage charged positive electrode active material. In addition, a positive electrode active material in which constant current charging is performed on LiCoO₂, in an environment at 25° C. and charging voltage of from 4.525 V to 4.65 V, inclusive, (in the case of a lithium counter electrode), and then subjected to constant voltage charging until the current value becomes 0.01 C or approximately ⅕ to 1/100 of the current value at the time of the constant current charging is also referred to as a high-voltage charged positive electrode active material.

Similarly, discharging refers to transfer of electrons from a negative electrode to a positive electrode in an external circuit. For a positive electrode active material, insertion of lithium ions is called discharging. A positive electrode active material with a charge depth of less than or equal to 0.06 or a positive electrode active material from which 90% or more of the charge capacity is discharged from a state where the positive electrode active material is charged with high voltage is referred to as a sufficiently discharged positive electrode active material. For example, LiCoO₂ with a charge capacity of 219.2 mAh/g is in a state of being charged with high voltage, and a positive electrode active material from which more than or equal to 197.3 mAh/g, which is 90% of the charge capacity, is discharged is a sufficiently discharged positive electrode active material. In addition, a positive electrode active material in which constant current discharging is performed on LiCoO₂ in an environment at 25° C. until the battery voltage becomes lower than or equal to 3 V (in the case of a lithium counter electrode) is also referred to as a sufficiently discharged positive electrode active material.

In this specification and the like, an example in which a lithium metal is used for a counter electrode in a secondary battery including a positive electrode and a positive electrode active material of one embodiment of the present invention is described in some cases; however, the secondary battery of one embodiment of the present invention is not limited to this example. A different material such as graphite or lithium titanate may be used for a negative electrode, for example. The properties of the positive electrode and the positive electrode active material of one embodiment of the present invention, such as a crystal structure unlikely to be broken by repeated charging and discharging and excellent cycle performance, are not affected by the material of the negative electrode. For example, the secondary battery of one embodiment of the present invention using a lithium counter electrode is charged and discharged at a relatively high charging voltage of 4.6 V in some cases; however, charging and discharging may be performed at a lower voltage. Charging and discharging at a lower voltage will result in cycle performance better than that described in this specification and the like.

### Embodiment 1

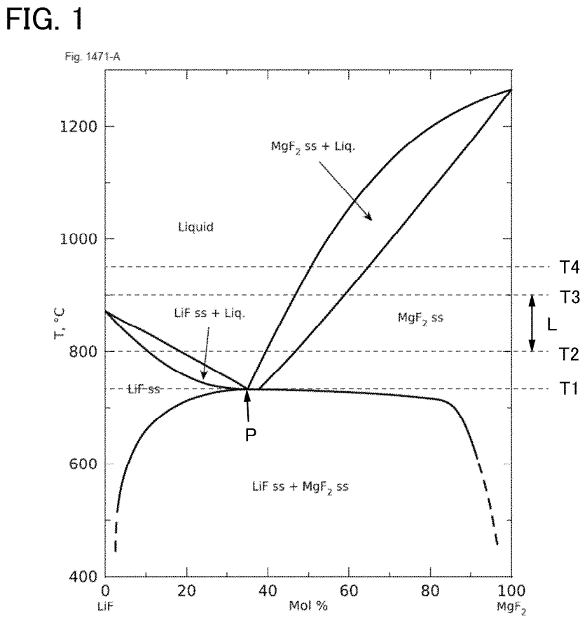

An example of a method for forming the LiMO₂ (M is two or more kinds of metals including Co, and the substitution positions of the metals are not particularly limited) is described with reference to FIG. 1 to FIG. 4. A positive electrode active material containing Mg as a metal element contained in LiMO₂ other than Co is described below as an example.

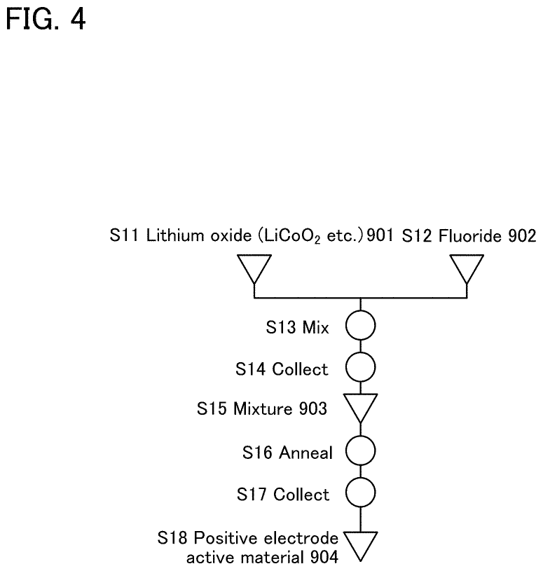

A flowchart illustrated in FIG. 4 is described. As the material for the lithium oxide 901, a composite oxide containing lithium, a transition metal, and oxygen is used.

The composite oxide containing lithium, a transition metal, and oxygen can be synthesized by heating a lithium source and a transition metal source in an oxygen atmosphere. As the transition metal source, a metal that can form, together with lithium, a layered rock-salt composite oxide belonging to the space group R-3m is preferably used. For example, at least one of manganese, cobalt, and nickel can be used. That is, as the transition metal source, only a cobalt source may be used; only a nickel source may be used; two types of cobalt and manganese sources or two types of cobalt and nickel sources may be used; or three types of cobalt, manganese, and nickel sources may be used. The heating temperature at this time is preferably higher than the temperature in Step S16 described later. For example, the heating can be performed at 1000° C. This heating step is referred to as baking in some cases.

In the case where a composite oxide containing lithium, a transition metal, and oxygen that is synthesized in advance is used, a composite oxide with few impurities is preferably used. In this specification and the like, lithium, cobalt, nickel, manganese, aluminum, and oxygen are the main components of the composite oxide containing lithium, a transition metal, and oxygen and the positive electrode active material, and elements other than the main components are regarded as impurities. For example, when analyzed with a glow discharge mass spectroscopy method, the total impurity concentration is preferably 10000 ppmw (parts per million weight) or less, further preferably 5000 ppmw or less. In particular, the total impurity concentration of transition metals such as titanium and arsenic is preferably 3000 ppmw or less, further preferably 1500 ppmw or less.

Examples of the lithium cobalt oxide synthesized in advance include a lithium cobalt oxide particle (product name: CELLSEED C-10N) formed by NIPPON CHEMICAL INDUSTRIAL CO., LTD. This is lithium cobalt oxide in which the average particle diameter (D50) is approximately 12 μm, and in the impurity analysis by a glow discharge mass spectroscopy method (GD-MS), the magnesium concentration and the fluorine concentration are 50 ppmw or less, the calcium concentration, the aluminum concentration, and the silicon concentration are 100 ppmw or less, the nickel concentration is 150 ppmw or less, the sulfur concentration is 500 ppmw or less, the arsenic concentration is 1100 ppmw or less, and the concentrations of elements other than lithium, cobalt, and oxygen are 150 ppmw or less.

The lithium oxide 901 in Step S11 preferably has a layered rock-salt crystal structure with few defects and distortions. Therefore, the composite oxide is preferably a composite oxide with few impurities. In the case where the composite oxide containing lithium, the transition metal, and oxygen includes a large amount of impurities, the crystal structure is highly likely to have a large number of defects or distortions.

Furthermore, a fluoride 902 of Step S12 is prepared. As the fluoride, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. As the fluoride 902, any material that functions as a fluorine source can be used. Thus, in place of the fluoride 902 or as part thereof, fluorine (F₂), carbon fluoride, sulfur fluoride, oxygen fluoride (OF₂, O₂F₂, O₃F₂, O₄F₂, or O₂F), or the like may be used and mixed in an atmosphere.

In this embodiment, lithium fluoride (LiF) is prepared as the fluoride 902. LiF is preferable because it has a cation common with LiCoO₂. LiF, which has a relatively low melting point of 848° C., is preferable because it is easily melted in an annealing process described later. Moreover, a material containing magnesium, such as MgF₂, may be used, in addition to LiF. When the fluoride 902 contains magnesium, magnesium can be placed in the vicinity of the surface of the positive electrode active material at high concentration.

Another element source may be mixed into the fluoride 902. For example, a titanium source, an aluminum source, a nickel source, a vanadium source, a manganese source, an iron source, a chromium source, a niobium source, a zinc source, a zirconium source, or the like can be mixed. For example, a hydroxide, a fluoride, or the like of each element is preferably pulverized and mixed. The pulverization can be performed by a wet process, for example.

In addition, it is acceptable which Step S11 or Step S12 is performed first.

Next, mixing and grinding are performed in Step S13. Although the mixing can be performed by a dry process or a wet process, the wet process is preferable because the materials can be ground to a smaller size. When the grinding and mixing are performed by a wet method, a solvent is prepared. As the solvent, ketone such as acetone; alcohol such as ethanol or isopropanol; ether; dioxane; acetonitrile; N-methyl-2-pyrrolidone (NMP); or the like can be used. An aprotic solvent that hardly reacts with lithium is further preferably used. In this embodiment, acetone is used.

For example, a ball mill, a bead mill, or the like can be used for the mixing. When the ball mill is used, a zirconia ball is preferably used as media, for example. The mixing and grinding steps are preferably performed sufficiently to pulverize the mixture 903.

The materials mixed and ground in the above manner are collected (Step S14 in FIG. 4), whereby the mixture 903 is obtained (Step S15 in FIG. 4).

For example, the D50 of the mixture 903 is preferably greater than or equal to 600 nm and less than or equal to 20 μm, further preferably greater than or equal to 1 μm and less than or equal to 10 μm.

Then, the mixture 903 is heated (Step S16 in FIG. 4). This step is referred to as annealing in some cases. LiMO₂ is produced by the annealing. Thus, the conditions of performing Step S16, such as temperature, time, an atmosphere, or weight of the mixture 903 to be annealed, are important. The meaning of annealing in this specification, includes a case where the mixture 903 is heated and a case where a heating furnace in which at least the mixture 903 is placed is heated. The heating furnace in this specification is equipment used for performing heat treatment (annealing) on a substance or a mixture and includes a heater, an atmosphere containing a fluoride and an inner wall that can withstand at least 600° C. Furthermore, the heating furnace may be provided with a pump having a function of reducing and/or increasing pressure in the heating furnace. For example, pressure may be applied during the annealing in S16.

The annealing temperature in S16 should be higher than or equal to the temperature at which a reaction between the lithium oxide 901 and the fluoride 902 can progress. The temperature at which a reaction can progress can be a temperature at which mutual diffusion of elements contained in the lithium oxide 901 and the fluoride 902 can occur. Thus, the temperature may be lower than the melting temperatures of these materials. For example, in an oxide, solid phase diffusion occurs at a temperature of 0.757 times the melting temperature Tₘ (Tamman temperature T_{d}). For this reason, the temperature may be, for example, higher than or equal to 500° C.

Note that a temperature higher than or equal to the temperature at which at least part of the mixture 903 is melted is preferable, in which case the reaction can more easily proceed. Therefore, the annealing temperature is preferably higher than or equal to the eutectic point of the fluoride 902. In the case where the fluoride 902 includes LiF and MgF₂, the eutectic point P of LiF and MgF₂ is near 742° C. (T1) as shown in FIG. 1 (which is cited from FIG. 1471-A of Non-Patent Document 1 and retouched) and thus the annealing temperature in S16 is preferably 742° C. or higher.

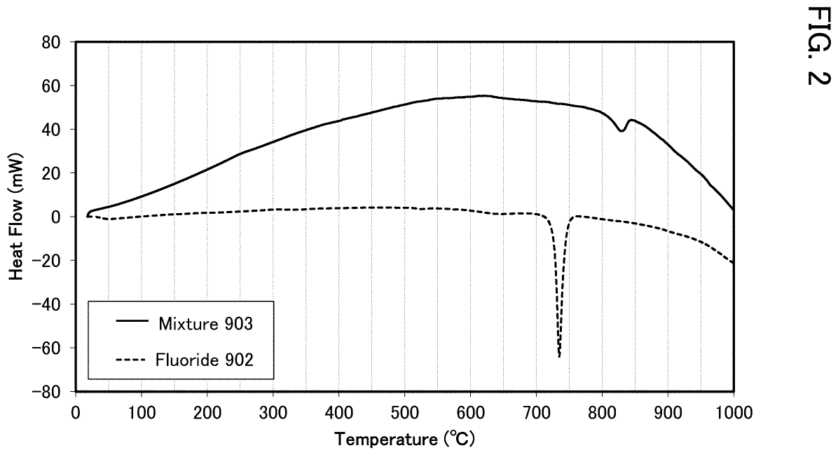

Here, the differential scanning calorimetry measurement (DSC measurement) of the fluoride 902 and the mixture 903 is described with reference to FIG. 2. In FIG. 2, the vertical axis represents Heat Flow and the horizontal axis represents Temperature. The fluoride 902 in FIG. 2 is a mixture of LiF and MgF₂. LiF and MgF₂ were mixed in a molar ratio of LiF:MgF₂=1:3 (molar ratio). The mixture 903 in FIG. 2 is obtained by mixing of lithium cobalt oxide as the lithium oxide 901 and LiF and MgF₂ as the fluoride 902. Lithium cobalt oxide, LiF, and MgF₂ are mixed in a molar ratio of LiCoO₂:LiF:MgF₂=100:0.33:1 (molar ratio).

As shown in FIG. 2, the endothermic peak of the fluoride 902 was observed around 735° C. In addition, the endothermic peak of the mixture 903 was observed around 830° C. Thus, the annealing temperature is preferably higher than or equal to 742° C., further preferably higher than or equal to 830° C. Alternatively, 800° C. (T2 in FIG. 1) or higher between the temperatures may be employed.

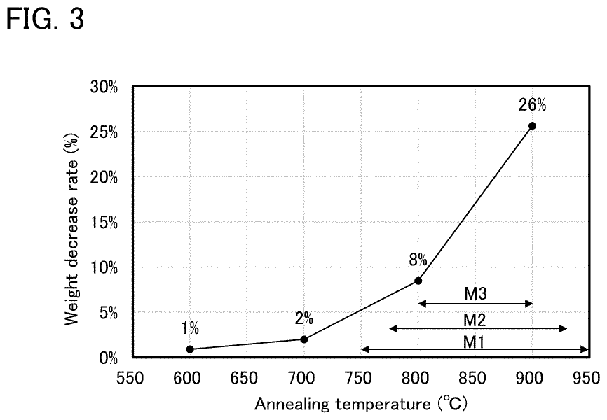

Evaporation or sublimation of the fluoride 902 is described with reference to FIG. 3. FIG. 3 is a graph showing the decrease rate of the weight of the fluoride 902, which is obtained by mixing in the molar ratio of LiF:MgF₂=1:3 (molar ratio), when the fluoride 902 is heated at 600° C., 700° C., 800° C., and 900° C. without the lid of the container. Each heating was performed in an oxygen atmosphere for ten hours.

As shown in FIG. 3, while the decrease rate of the weight after the heating is 2% at 700° C., it is 8% at 800° C. and it is 26% at 900° C. This shows that evaporation or sublimation of the fluoride 902 rapidly progresses from approximately 800° C.

A higher annealing temperature is preferable because it facilitates the reaction, shortens the annealing time, and enables high productivity.

Note that the annealing temperature needs to be lower than or equal to the decomposition temperature of LiCoO₂ (1130° C.). Although the decomposition temperature of LiCoO₂ is 1130° C., decomposition of a slight amount of LiCoO₂ is concerned at a temperature close to the decomposition temperature. Therefore, the annealing temperature is preferably lower than or equal to 1130° C., further preferably lower than or equal to 1000° C., still further preferably lower than or equal to 950° C. (T4), yet still further preferably lower than or equal to 900° C. (T3).

Therefore, as shown in FIG. 3, the annealing temperature is preferably 850° C.±100° C. (from 750° C. to 950° C., inclusive) as shown by M1, the annealing temperature is further preferably 850° C.±75° C. (from 775° C. to 925° C., inclusive) as shown by M2, the annealing temperature is most preferably 850° C.±50° C. (from 800° C. to 900° C., inclusive) as shown by M3.

Specifically, the annealing temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the annealing temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the annealing temperature is preferably higher than or equal to 800° C. and lower than or equal to 1130° C., further preferably higher than or equal to 800° C. and lower than or equal to 1000° C., still further preferably higher than or equal to 800° C. and lower than or equal to 950° C., most preferably higher than or equal to 800° C. (T2) and lower than or equal to 900° C. (T3) (the range L). Furthermore, the annealing temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

More specifically, LiF is used as the fluoride 902 and the annealing in S16 is conducted with the lid put on, whereby a positive electrode active material 904 with good cycle characteristics and the like can be formed. When LiF and MgF₂ are used as the fluoride 902, the reaction with LiCoO₂ is considered to be promoted to produce LiMO₂.

In this embodiment, LiF, which is a fluoride, is considered to function as flux. Accordingly, since the capacity of the heating furnace is larger than the capacity of the container and LiF is lighter than oxygen, it is though that LiF is volatilized and the reduction of LiF in the mixture 903 may inhibit production of LiMO₂. Therefore, heating needs to be performed while volatilization of LiF is inhibited. Even if LiF is not used, LiF may be generated from the reaction between Li and F of the surface of the lithium oxide 901 and may be volatilized. Therefore, such inhibition of volatilization is needed also when a fluoride having a higher melting point than LiF is used.

Thus, when the mixture 903 is heated in an atmosphere including LiF, that is, the mixture 903 is heated in a state where the partial pressure of LiF in the heating furnace is high, volatilization of LiF in the mixture 903 can be inhibited. By performing annealing using the fluoride (LiF or MgF) to form an eutectic mixture with the lid put on, the annealing temperature can be lowered to the decomposition temperature (1130° C.) or lower of the LiCoO₂, specifically, a temperature of 742° C. to 1000° C., inclusive, thereby enabling the production of LiMO₂ to progress efficiently. Accordingly, a positive electrode active material having excellent characteristics can be formed, and the annealing time can be reduced.

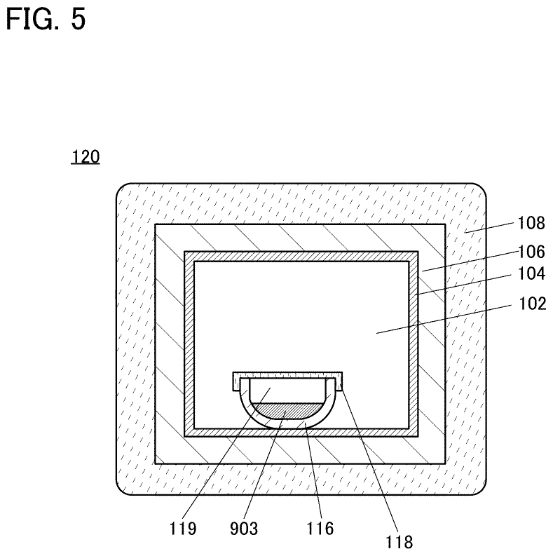

FIG. 5 illustrates an example of the annealing method in S16.

A heating furnace 120 illustrated in FIG. 5 includes a space 102 in the heating furnace, a hot plate 104, a heater 106, and a heat insulator 108. It is more preferable to put a lid 118 on the container 116 in annealing. With this structure, an atmosphere including a fluoride can be obtained in a space 119 enclosed by the container 116 and the lid 118. In the annealing, the state of the space 119 is maintained with the lid on the container so that the concentration of the gasified fluoride inside the space 119 can be constant or cannot be reduced, in which case fluorine or magnesium can be contained in the vicinity of the particle surface. The atmosphere including a fluoride can be provided in the space 119, which is smaller in capacity than the space 102 in the heating furnace, by volatilization of a smaller amount of a fluoride. This means that an atmosphere including a fluoride can be provided in the reaction system without a significant reduction in the amount of a fluoride included in the mixture 903. Accordingly, LiMO₂ can be produced efficiently. In addition, the use of the lid 118 allows the annealing of the mixture 903 in an atmosphere including a fluoride to be simply and inexpensively performed.

Here, the valence number of Co (cobalt) in LiMO₂ formed by one embodiment of the present invention is preferably approximately 3. The valence number of cobalt can be 2 or 3. Thus, to inhibit reduction of cobalt, it is preferable that the atmosphere in the space 102 in the heating furnace contain oxygen, the ratio of oxygen to nitrogen in the atmosphere in the space 102 in the heating furnace be higher than or equal to that in the air atmosphere, and the oxygen concentration in the atmosphere in the space 102 in the heating furnace be higher than or equal to that in the air atmosphere. Thus, an atmosphere including oxygen needs to be introduced into the space in the heating furnace. Note that since bivalent cobalt atoms existing near magnesium atoms are likely to be stable, not all the cobalt atoms may be trivalent.

Thus, in one embodiment of the present invention, before heating is performed, the step of providing an atmosphere including oxygen in the space 102 in the heating furnace and the step of placing the container 116 in which the mixture 903 is placed in the space 102 in the heating furnace are performed. The steps in this order enable the mixture 903 to be annealed in an atmosphere including oxygen and a fluoride. During the annealing, the space 102 in the heating furnace is preferably sealed to prevent any gas from being discharged to the outside. For example, it is preferable not to conduct a gas flow in the annealing.

Although there is no particular limitation on the method of providing an atmosphere including oxygen in the space 102 in the heating furnace, examples are a method of introducing an oxygen gas or a gas containing oxygen such as dry air after exhausting air from the space 102 in the heating furnace and a method of flowing an oxygen gas or a gas containing oxygen such as dry air into the space 102 for a certain period of time. In particular, introducing an oxygen gas after exhausting air from the space 102 in the heating furnace (oxygen displacement) is preferred. The atmosphere of the space 102 in the heating furnace may be regarded as an atmosphere containing oxygen.

When the lid 118 is put on the container 116, an atmosphere containing oxygen is provided, and then heating is performed, an appropriate amount of oxygen enters the container 116 through a gap of the lid 118 put on the container 116 and an appropriate amount of fluoride can be kept within the container 116.

Furthermore, the fluoride or the like attached to inner walls of the container 116 and the lid 118 is likely to be fluttered again by the heating and attached to the mixture 903.

There is no particular limitation on the step of heating the heating furnace 120. The heating may be performed using a heating mechanism included in the heating furnace 120.

Although there is no particular limitation on the way of placing the mixture 903 in the container 116, as illustrated in FIG. 5, the mixture 903 is preferably provided so that the top surface of the mixture 903 is flat on the bottom surface of the container 116, in other words, the level of the top surface of the mixture 903 becomes uniform.

The annealing in Step S16 is preferably performed at an appropriate temperature for an appropriate time. The appropriate temperature and time change depending on the conditions such as the particle size and the composition of the lithium oxide 901 particle in Step S11. In the case where the particle size is small, the annealing is preferably performed at a lower temperature or for a shorter time than the case where the particle size is large, in some cases. The step of removing the lid is included after the annealing in S16.

For example, in the case where the D50 of particles in Step S11 is approximately 12 nm, the annealing time is preferably 3 hours or longer, further preferably 10 hours or longer.

By contrast, in the case where the D50 of particles in Step S11 is approximately 5 nm, the annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

The materials annealed in the above manner are collected (Step S17 in FIG. 4), whereby a positive electrode active material 904 is obtained (Step S18 in FIG. 4).

Here, in the annealing in S16, the difference between a particle obtained by annealing using the lid and a particle obtained by annealing without using the lid, which is a comparative example, is described next.

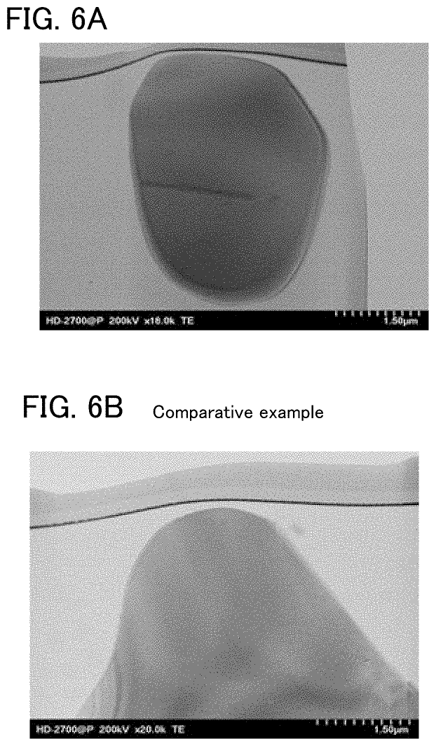

FIG. 6A shows an example of a cross-sectional image obtained by STEM observation of one of the positive electrode active material particles obtained by annealing using the lid. FIG. 6B shows an example of a cross-sectional image obtained by STEM observation of one of the positive electrode active material particles obtained by annealing without using the lid. Note that in FIG. 6A and FIG. 6B, the positive electrode active material particles are surrounded by resin and STEM observation is conducted after a protective film is formed.

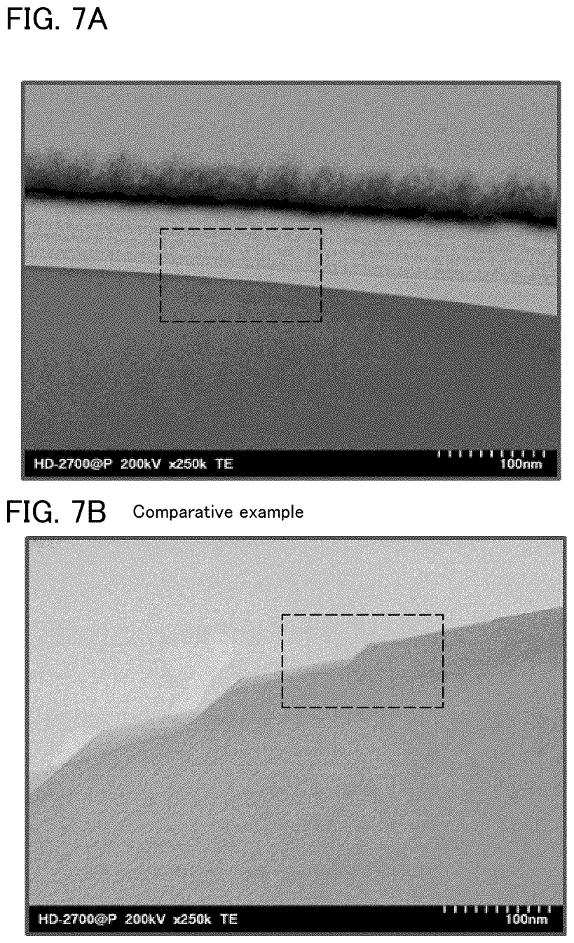

FIG. 7A is an enlarged view of part of the obtained image shown in FIG. 6A. FIG. 7B is an enlarged view of part of FIG. 6B which is the comparative example. The state of the particle surface in FIG. 7A can be observed to be smooth, or slick or shiny, as compared with that in FIG. 7B.

A method and a procedure for quantifying the unevenness of a particle surface to clarify the difference between the particle surfaces are described next.

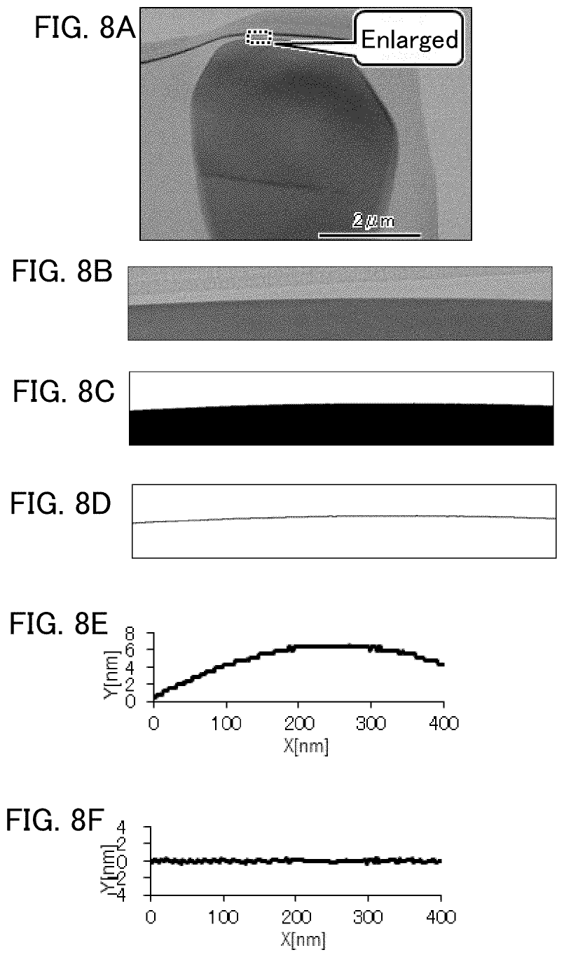

FIG. 8A is the same as FIG. 6A. FIG. 8B is an enlarged and trimmed image of the region surrounded by a dotted line in FIG. 8A. In this embodiment, the region surrounded by the dotted line is trimmed as a region for observing the roughness of the particle. An upper portion of the image of FIG. 8B is a resin formed as the protective film for STEM observation, a lower portion of the image is the positive electrode active material particle, and the interface is the outermost shell of the particle surface.

In order to perform noise processing of FIG. 8B, after Gaussian blur (σ=2) is performed, image processing software is used for binarization. The image after the binarization is FIG. 8C. With extraction of the interface with use of the image processing software, FIG. 8D is obtained. Note that the image processing software used for the noise processing, the interface extraction, or the like is not particularly limited, and “ImageJ” can be used, for example. In addition, the spreadsheet software or the like is not particularly limited, and Microsoft Office Excel can be used, for example.

A target boundary line in the image data of FIG. 8D is selected with use of magic hand tool and data is extracted in Excel. Numerical data extracted in Excel is shown graphically in FIG. 8E.

With use of the function of Excel, correction is conducted from a regression line (second regression) and a roughness calculation parameter is obtained from the tilt-corrected data. The absolute values of the tilt-corrected data are averaged and the square root of the average is represented by RMS, which is shown in FIG. 8F. The surface roughness is RMS obtained by calculation of the standard deviation. This surface roughness refers to the surface roughness in at least 400 nm of the particle periphery of the positive electrode active material.

In the particle surface of the positive electrode active material of this embodiment, the roughness (RMS) that is an indicator of roughness is 0.1 nm by calculation. The surface is modified by heating with the lid on after the fluoride is mixed; consequently, a positive electrode active material having RMS of less than 3 nm, preferably less than 1 nm, further preferably less than 0.5 nm can be easily obtained.

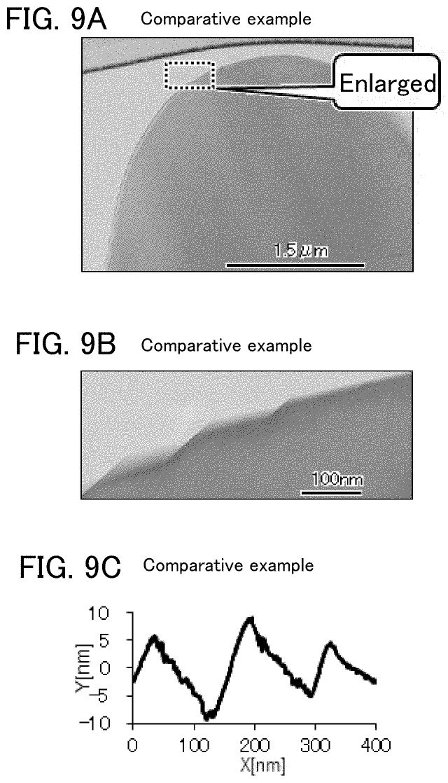

When the RMS calculation is performed similarly on the comparative example, FIG. 9A is the same as FIG. 6B and FIG. 9B is image data obtained by trimming of a region surrounded by a dotted line in FIG. 9A. Numerical data which are shown graphically with the same procedure as the above method are shown in FIG. 9C. In addition, the roughness (RMS) that is an indicator of roughness is 3.3 nm by calculation in the particle surface of the comparative example.

### Embodiment 2

In this embodiment, an example of manufacturing a battery cell using LiMO₂ formed by the manufacturing method of one embodiment of the present invention will be described. Since many parts are common, a manufacturing method thereof is described with reference to FIG. 4.

Lithium cobalt oxide is prepared as the oxide 901. Specifically, CELLSEED C-10N manufactured by NIPPON CHEMICAL INDUSTRIAL CO., LTD. is prepared (Step S11).

LiF and MgF₂ are prepared for the fluoride 902. LiF and MgF₂ are weighted so that the molar ratio of LiF to MgF₂ is LiF:MgF₂: 1:3, acetone is added as a solvent, and the materials are mixed and ground by a wet process. LiF to lithium cobalt oxide is set to 0.17 mol %. MgF₂ to lithium cobalt oxide is set to 0.5 mol %.

The lithium oxide 901 and the fluoride 902 are mixed and collected to give the mixture 903.

Then, the mixture 903 is put in a container and a lid is put on the container. The inside of the heating furnace is set to an oxygen atmosphere and annealing is performed. The annealing temperature might be different depending on the weight of the mixture 903, but is preferably from 742° C. to 1000° C., inclusive. “Annealing temperature” is a temperature at the time of the annealing, and “Annealing time” is time for holding the annealing temperature. The temperature rising rate is 200° C./h, and the temperature decreasing time is longer than or equal to 10 hours. Furthermore, it is preferable not to positively supply a gas during the annealing so as to prevent release of gaseous fluoride to the outside. For example, it is preferable not to perform the annealing without a gas flow.

In this embodiment, the annealing temperature of 850° C., 60 hours, and an oxygen atmosphere in the heating furnace are employed.

After the annealing, the positive electrode active material 904 can be collected. When a surface without unevenness is obtained, the lid may be removed during the heating for cooling. After the cooling, the lid is removed and the obtained positive electrode active material 904 is used to form each positive electrode. A current collector that is coated with slurry in which the positive electrode active material, AB, and PVDF are mixed at the active material:AB:PVDF=95:3:2 (weight ratio) is used. As a solvent of the slurry, NMP is used.

After the current collector is coated with the slurry, the solvent is evaporated. Then, pressure is applied at 210 kN/m, and then pressure is applied at 1467 kN/m. Through the above process, the positive electrode is obtained. The carried amount of the positive electrode is approximately 7 mg/cm², and the density of the positive electrode active material is >3.8 g/cc.

Using the formed positive electrodes, CR2032 type coin battery cells (a diameter of 20 mm, a height of 3.2 mm) are formed.

A lithium metal is used for a counter electrode.

As an electrolyte contained in the electrolyte solution, 1 mol/L lithium hexafluorophosphate (LiPF₆) is used. As the electrolyte solution, an electrolyte solution in which ethylene carbonate (EC) and diethyl carbonate (DEC) are mixed at EC:DEC=3:7 (volume ratio) is used. Note that 2 wt % vinylene carbonate (VC) is added as an additive to the electrolyte solution.

As a separator, 25-μm-thick polypropylene is used.

A positive electrode can and a negative electrode can that are formed using stainless steel (SUS) are used.

Through the above steps, a secondary battery cell can be formed.

The comparison results of experiments conducted under different annealing conditions are shown below.

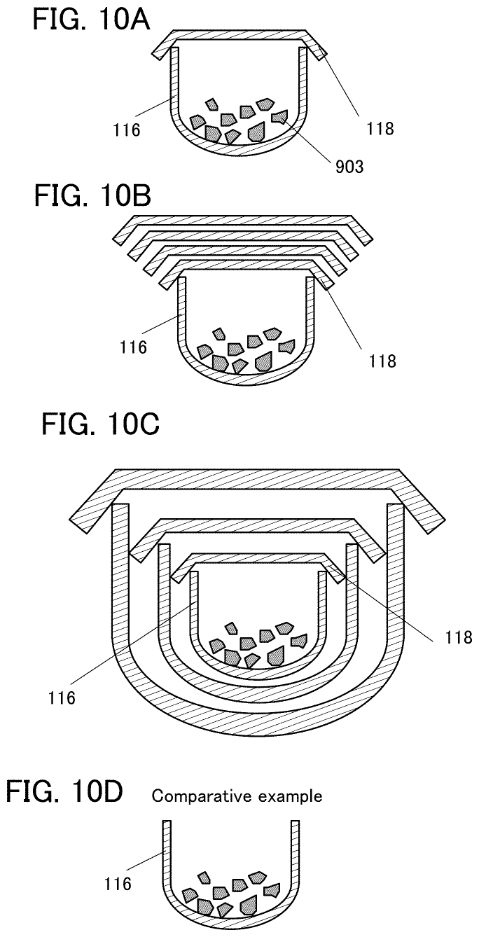

FIG. 10A illustrates Condition 1 that is the same as the above-described manufacturing method and is the same as FIG. 5, using the same reference numerals in FIG. 5. As Condition 2, four lids are prepared as illustrated in FIG. 10B. As Condition 3, triple containers and triple lids are used as illustrated in FIG. 10C. The same material, specifically, a ceramics material, is used for each of the containers and the lids. The lid is larger than the opening of the container, and the lid is set by its self-weight. No gap is preferred between the lid and the container as much as possible, but the lid has a gap to prevent the inside of the container from being airtight with the lid. Condition 1, Condition 2, and Condition 3 are the same in the procedure and conditions, excluding the difference of the conditions illustrated in FIG. 10.

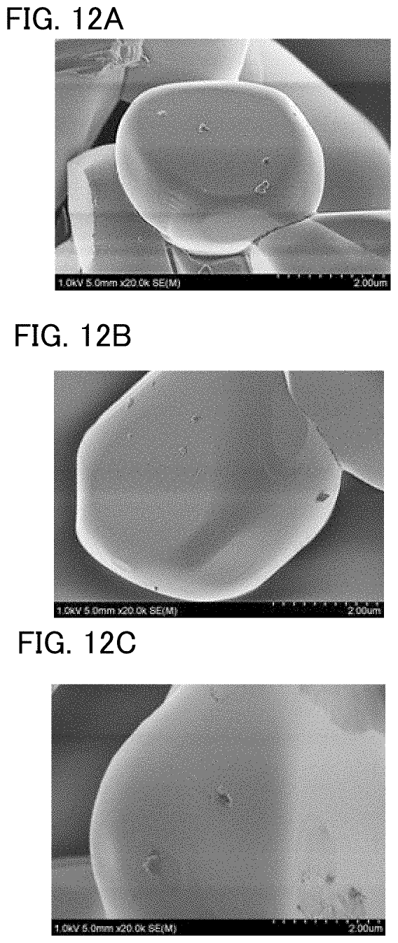

The same annealing is performed under Condition 1, Condition 2, and Condition 3, and SEM images of the obtained particles are shown in FIG. 12A, FIG. 12B, and FIG. 12C. Condition 1, Condition 2, and Condition 3 correspond to FIG. 12A, FIG. 12B, and FIG. 12C, respectively. The use of the lid in all the conditions can make the surface of each active material particle have almost no cracks or protrusions, and the surface observed in the SEM image is found to be slick or shiny. Fluorine is important to obtain flatness, in other words, no unevenness on the surface, and a lid is used to prevent the release of a fluorine gas to the outside, which leads to a regular formation of bonds in the particle surface. In addition, by containing fluorine in the vicinity of the surface, magnesium can also be present at high concentration in the vicinity of the surface, in addition to the fluorine.

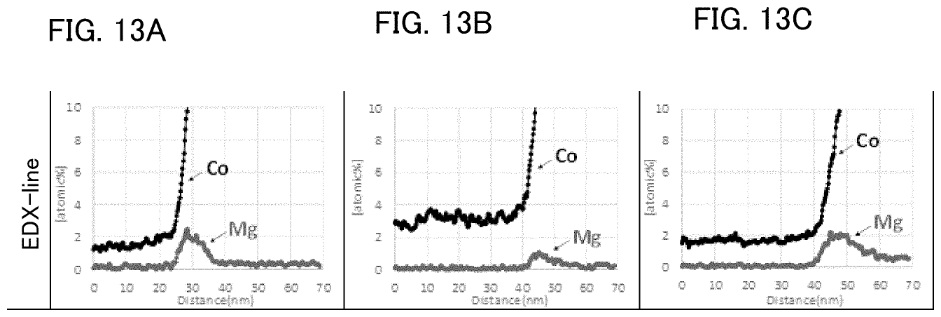

Part of the particle in FIG. 12A of Condition 1 is measured by EDX, whereby a peak of magnesium is confirmed in the vicinity of the particle surface. FIG. 13A shows the EDX result. The horizontal axis in FIG. 13A represents a depth direction (Distance). Because the position close to the detection position of cobalt can be determined to be the position of the outermost shell of the particle, the peak of magnesium can be confirmed in the vicinity of the particle surface. The EDX measurement result of part of the particle in FIG. 12B is shown in FIG. 13B. The EDX measurement result of part of the particle in FIG. 12C is shown in FIG. 13C. The EDX measurement result of any condition shows uneven distribution of magnesium in the particle surface of the positive electrode active material. Magnesium in the vicinity of the particle surface has a function of maintaining the crystal structure (a layered rock-salt crystal structure) even when Li is deintercalated at the time of discharging. Although in the EDX result, the peak of magnesium is observed only in the surface, magnesium is included in the particle, of course. In addition, a deviation in the CoO₂ layers can be small in repeated high-voltage charging and discharging. Further, a change in volume in repeated charging and discharging can be reduced. Therefore, the cycle characteristics of secondary batteries using the positive electrode active material having such a feature are greatly improved.

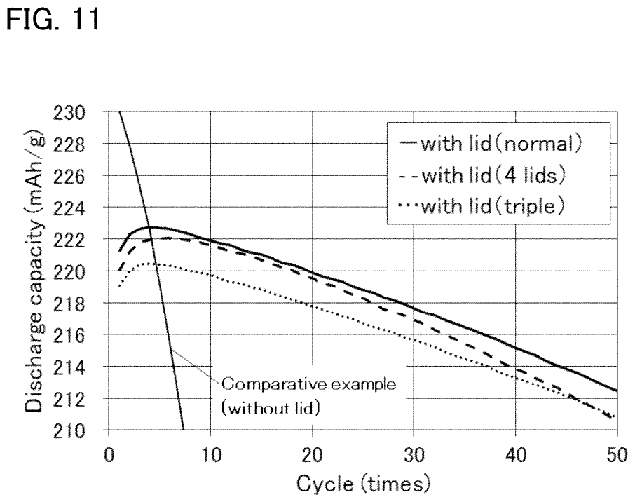

FIG. 11 shows cycle characteristics of battery cells under Condition 1, Condition 2, and Condition 3. The cycle performances were evaluated at 25° C. while the CCCV charging (0.5 C, 4.6 V, termination current of 0.05 C) and the CC discharging (0.5 C, 2.5 V) were performed. FIG. 11 shows the results.

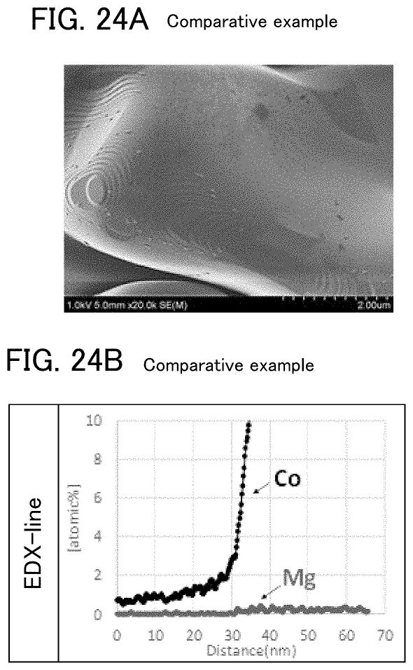

FIG. 11 shows cycle characteristics in the case where a battery cell is fabricated under the conditions where no lid is used and the other conditions are the same as Condition 1, as a comparative example illustrated in FIG. 10D. FIG. 24A shows a SEM image of the particle of the comparative example. The SEM image gives an impression of roughness in the particle surface of the comparative example. A large number of minute protrusions on the surface can be viewed, which is greatly different from the results of Conditions 1, 2, and 3. FIG. 24B shows the EDX measurement result of part of the particle in FIG. 24A. The horizontal axis in FIG. 24B represents a distance (Distance). There are no peak of magnesium in the comparative example without using a lid. In the case of the comparative example in which annealing is performed without using a lid, fluorine is released from the inside of the particle to the outside, and there are almost no magnesium in the surface. Thus, breakage of the crystal structure is caused by a distortion when charging and discharging are performed; thus, as shown in FIG. 11, the cycle characteristics are decreased.

From the above, it can be confirmed that the conditions for the annealing using lids (Condition 1, Condition 2, and Condition 3) show excellent cycle characteristics compared to the comparative example under the annealing condition without using a lid.

### Embodiment 3

In this embodiment, an example of a structure of a positive electrode active material formed by the manufacturing method according to one embodiment of the present invention is described.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. As an example of the element M, one or more elements selected from Co, Ni, and Mn can be given. As another example of the element M, in addition to one or more elements selected from Co, Ni, and Mn, one or more elements selected from Al and Mg can be given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charging and discharging are performed on LiNiO₂, the crystal structure might be broken because of the distortion. The influence of the Jahn-Teller effect is suggested to be small in LiCoO₂; hence, LiCoO₂ is preferable because the resistance to high-voltage charging and discharging is higher in some cases.

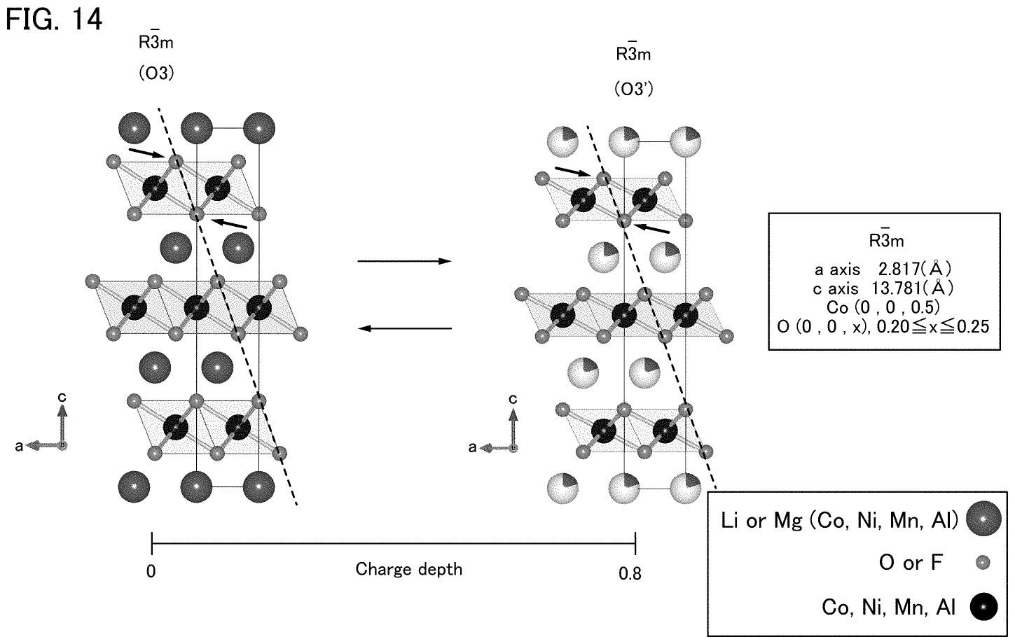

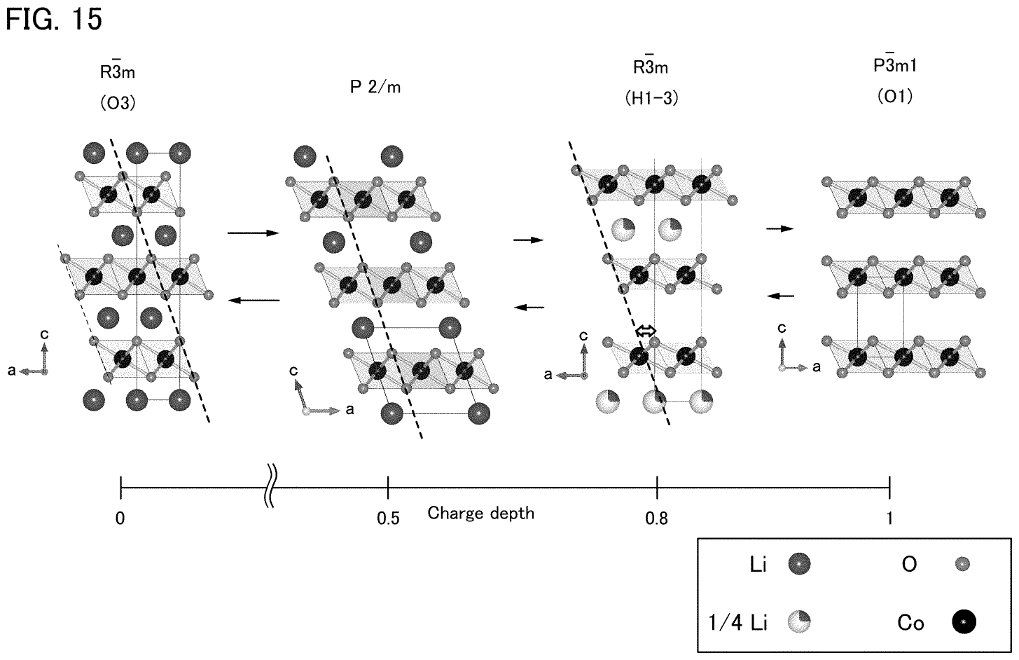

Positive electrode active materials are described with reference to FIG. 14 and FIG. 15. With FIG. 14 and FIG. 15, the case of using cobalt as a transition metal contained in the positive electrode active materials is described.

### <Conventional Positive Electrode Active Material>

A positive electrode active material illustrated in FIG. 15 is lithium cobalt oxide (LiCoO₂) to which halogen and magnesium are not added. In the lithium cobalt oxide illustrated in FIG. 15, the crystal structure is changed by the charge depth.

As illustrated in FIG. 15, lithium cobalt oxide with a charge depth of 0 (the discharged state) includes a region having the crystal structure of the space group R-3m, and includes three CoO₂ layers in a unit cell. Thus, this crystal structure is referred to as an O3-type crystal structure in some cases. Note that the CoO₂ layer has a structure in which octahedral geometry with oxygen hexacoordinated to cobalt continues on a plane in the edge-sharing state.

When the charge depth is 1, LiCoO₂ has the crystal structure of the space group P-3ml, and one CoO₂ layer exists in a unit cell. Thus, this crystal structure is referred to as an O1-type crystal structure in some cases.

Moreover, lithium cobalt oxide when the charge depth is approximately 0.88 has the crystal structure of the space group R-3m. This structure can also be regarded as a structure in which CoO₂ structures such as P-3ml (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 15, the c-axis of the H1-3 type crystal structure is illustrated half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt and two oxygens. Meanwhile, the O3′ type crystal structure of one embodiment of the present invention is preferably represented by a unit cell including one cobalt and one oxygen, as described later. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (goodness of fit) is smaller in Rietveld analysis of XRD patterns, for example.

When charge with a high voltage of 4.6 V or higher based on the redox potential of a lithium metal or charge with a large charge depth of 0.8 or more and discharge are repeated, the crystal structure of lithium cobalt oxide changes (i.e., an unbalanced phase change occurs) repeatedly between the H1-3 type crystal structure and the R-3m (O3) structure in a discharged state.

However, there is a large deviation in the position of the CoO₂ layer between these two crystal structures. As indicated by the dotted line and the arrow in FIG. 15, the CoO₂ layer in the H1-3 type crystal structure largely deviates from that in R-3m (O3). Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are continuous, such as P-3ml (O1), included in the H1-3 type crystal structure is highly likely to be unstable.

Thus, the repeated high-voltage charging and discharging breaks the crystal structure of lithium cobalt oxide. The breakage of the crystal structure degrades the cycle performance. This is probably because the breakage of the crystal structure reduces sites where lithium can stably exist and makes it difficult to insert and extract lithium.

### <Positive Electrode Active Material of One Embodiment of the Present Invention>

In the positive electrode active material formed by one embodiment of the present invention, the difference in the positions of CoO₂ layers can be small in repeated charging and discharging at high voltage. Furthermore, the change in the volume can be small. Thus, the positive electrode active material can have excellent cycle performance. In addition, the compound can have a stable crystal structure in a high-voltage charged state. Thus, in the compound, a short circuit is less likely to occur while the high-voltage charged state is maintained. This is preferable because the safety is further improved.

The positive electrode active material of one embodiment of the present invention has a small change in the crystal structure and a small difference in volume per the same number of transition metal atoms between a sufficiently discharging state and a high-voltage charging state.

FIG. 14 illustrates the crystal structures before and after charging and discharging of the positive electrode active material 904 of one embodiment of the present invention. The positive electrode active material 904 is a composite oxide containing lithium, cobalt as a transition metal, and oxygen. In addition to the above, the positive electrode active material 904 preferably contains magnesium as an addition element. Furthermore, the positive electrode active material 904 preferably contains halogen such as fluorine or chlorine as an addition element.

The crystal structure with a charge depth of 0 (the discharged state) in FIG. 14 is R-3m (O3), which is the same as that in FIG. 15. Meanwhile, the positive electrode active material 904 with a charge depth in a sufficiently charged state has a crystal whose structure is different from the H1-3 type structure. This structure belongs to the space group R-3m, and is not a spinel crystal structure but a structure in which oxygen is hexacoordinated to ions of cobalt, magnesium, or the like and the cation arrangement has symmetry similar to that of the spinel crystal structure. Furthermore, the symmetry of CoO₂ layers of this structure is the same as that in the O3 type structure. This structure is thus referred to as the O3′ type crystal structure or the pseudo-spinel crystal structure in this specification and the like. Accordingly, the O3′ type crystal structure may be rephrased as the pseudo-spinel crystal structure. Note that although the indication of lithium is omitted in the diagram of the O3′ type crystal structure illustrated in FIG. 14 to explain the symmetry of cobalt atoms and the symmetry of oxygen atoms, for example, lithium in 20 atomic % or less with respect to cobalt practically exists between the CoO₂ layers. In addition, in both the O3 type crystal structure and the O3′ type crystal structure, a slight amount of magnesium preferably exists between the CoO₂ layers, i.e., in lithium sites. In addition, a slight amount of halogen such as fluorine preferably exists in oxygen sites at random.

Note that in the O3′ type crystal structure, oxygen is tetracoordinated to a light element such as lithium in some cases. Also in that case, the ion arrangement has symmetry similar to that of the spinel crystal structure.

The O3′ type crystal structure can also be regarded as a crystal structure that contains Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

In the positive electrode active material 904 of one embodiment of the present invention, a change in the crystal structure when high-voltage charge is performed and a large amount of lithium is extracted is inhibited as compared with a conventional positive electrode active material. As shown by dotted lines in FIG. 14, for example, CoO₂ layers hardly deviate in the crystal structures.

More specifically, the structure of the positive electrode active material 904 of one embodiment of the present invention is highly stable even when a charge voltage is high. For example, in a conventional positive electrode active material, the H1-3 type structure is formed at a charge voltage of approximately 4.6 V with reference to the potential of lithium metal; however, the positive electrode active material 904 of one embodiment of the present invention can maintain the R-3m (O3) crystal structure at the charge voltage of approximately 4.6 V. Further, even at a higher voltage, for example, 4.65 V to approximately 4.7 V with reference to the potential of lithium metal, the positive electrode active material 904 of one embodiment of the present invention can have the O3′ crystal structure. At a much higher charge voltage than 4.7 V, the H1-3 type structure is eventually observed in the positive electrode active material 904 of one embodiment of the present invention in some cases. In addition, the positive electrode active material 904 of one embodiment of the present invention can have the O3′ type structure even at a lower charge voltage (e.g., a charge voltage of greater than or equal to 4.5 V and less than 4.6 V with reference to the potential of a lithium metal in some cases.

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery which includes graphite as a negative electrode active material and which has a voltage of greater than or equal to 4.3 V and less than or equal to 4.5 V, for example, the positive electrode active material 904 of one embodiment of the present invention can maintain the crystal structure belonging to R-3m (O3) and moreover, can have the O3′ type crystal structure at higher voltages, e.g., a voltage of the secondary battery of greater than 4.5 V and less than or equal to 4.6 V. In addition, the positive electrode active material 904 of one embodiment of the present invention can have the O3′ type structure at lower charge voltages, e.g., at a voltage of the secondary battery of greater than or equal to 4.2 V and less than 4.3 V, in some cases.

Thus, in the positive electrode active material 904 of one embodiment of the present invention, the crystal structure is less likely to be broken even when charging and discharging are repeated at high voltage.

In addition, in the positive electrode active material 904, a difference in the volume per unit cell between the O3-type crystal structure with a charge depth of 0 and the O3′ type crystal structure with a charge depth of 0.88 is less than or equal to 2.5%, specifically, less than or equal to 2.2%.

In the unit cell of the O3′ type crystal structure, coordinates of cobalt and oxygen in a unit cell can be represented by Co (0, 0, 0.5) and O (0, 0, x) within the range of 0.20≤x≤0.25.

A slight amount of an addition element, e.g., magnesium, existing between the CoO₂ layers, i.e., in lithium sites at random, has an effect of inhibiting a deviation of the CoO₂ layers. Thus, when magnesium exists between the CoO₂ layers, the O3′ type crystal structure is likely to be formed. Therefore, magnesium is preferably distributed over the entire particle of the positive electrode active material 904 of one embodiment of the present invention. In addition, to distribute magnesium over the entire particle, heat treatment is preferably performed in the formation process of the positive electrode active material 904 of one embodiment of the present invention.

However, cation mixing occurs when the heat treatment temperature is too high, so that the addition element, e.g., magnesium is highly likely to enter the cobalt sites. Magnesium in the cobalt sites does not have the effect of maintaining the R-3m structure in high-voltage charging. Furthermore, when the heat treatment temperature is excessively high, adverse effects such as reduction of cobalt to have a valence of two and transpiration of lithium are concerned.

In view of the above, a halogen compound such as a fluorine compound is preferably added to lithium cobalt oxide before the heat treatment for distributing magnesium over whole particles. The addition of the halogen compound depresses the melting point of lithium cobalt oxide. The depression of the melting point makes it easier to distribute magnesium over whole particles at a temperature at which the cation mixing is unlikely to occur. Furthermore, it is expected that the existence of the fluorine compound can improve corrosion resistance to hydrofluoric acid generated by decomposition of an electrolyte solution.

When the magnesium concentration is higher than or equal to a predetermined value, the effect of stabilizing a crystal structure becomes small in some cases. This is probably because magnesium enters the cobalt sites as well as the lithium sites. The number of magnesium atoms in the positive electrode active material of one embodiment of the present invention is preferably 0.001 to 0.1 times, preferably larger than 0.01 times and less than 0.04 times, still further preferably approximately 0.02 times the number of a transition metal. The magnesium concentration described here may be a value obtained by element analysis on the entire particles of the positive electrode active material using ICP-MS or the like, or may be a value based on the ratio of the source materials mixed in the forming process of the positive electrode active material, for example.

To lithium cobalt oxide, as a metal other than cobalt (addition element), one or more metals selected from nickel, aluminum, manganese, titanium, vanadium, and chromium may be added, for example, and in particular, one or more of nickel and aluminum is preferably added. In some cases, manganese, titanium, vanadium, and chromium are likely to have a valence of four stably and thus contribute highly to a stable structure. The addition of the addition element may enable the positive electrode active material of one embodiment of the present invention to have a more stable crystal structure in high-voltage charge, for example. Here, in the positive electrode active material of one embodiment of the present invention, the addition element is preferably added at such a concentration that does not greatly change the crystallinity of the lithium cobalt oxide. For example, the addition element is preferably added at an amount with which the aforementioned Jahn-Teller effect is not exhibited.

As illustrated in the legend in FIG. 14, aluminum and transition metals typified by nickel and manganese preferably exist in cobalt sites, but some of them may exist in lithium sites. Magnesium preferably exists in lithium sites. Fluorine may be substituted for part of oxygen.

As the magnesium concentration in the positive electrode active material of one embodiment of the present invention increases, the capacity of the positive electrode active material decreases in some cases. As an example, one possible reason is that the amount of lithium that contributes to charging and discharging decreases when magnesium enters the lithium sites. Furthermore, excess magnesium sometimes generates a magnesium compound that does not contribute to charging and discharging. When the positive electrode active material of one embodiment of the present invention contains nickel as the addition element in addition to magnesium, the capacity per weight and per volume can be increased in some cases. When the positive electrode active material of one embodiment of the present invention contains aluminum as the addition element in addition to magnesium, the capacity per weight and per volume can be increased in some cases. When the positive electrode active material of one embodiment of the present invention contains nickel and aluminum in addition to magnesium, the capacity per weight and per volume can be increased in some cases.

The concentrations of the elements, such as magnesium, contained in the positive electrode active material of one embodiment of the present invention are described below using the number of atoms.

The number of nickel atoms in the positive electrode active material of one embodiment of the present invention is preferably 10.0% or less, more preferably 7.5% or less, further preferably 0.05% to 4%, still further preferably 0.1% to 2% of the number of cobalt atoms. The nickel concentration described here may be a value obtained by element analysis on the entire particle of the positive electrode active material using ICP-MS or the like, or may be a value based on the ratio of the source materials mixed in the forming process of the positive electrode active material, for example.

When a state being charged with high voltage is held for a long time, the transition metal dissolves into an electrolyte solution from the positive electrode active material, and the crystal structure might be broken. However, when nickel is included at the above-described proportion, dissolution of the transition metal from a positive electrode active material 904 can be inhibited in some cases.

The number of aluminum atoms in the positive electrode active material of one embodiment of the present invention is preferably 0.05% to 4%, further preferably 0.1% to 2% of the number of cobalt atoms. The aluminum concentration described here may be a value obtained by element analysis on the entire particle of the positive electrode active material using ICP-MS or the like, or may be a value based on the ratio of the source materials mixed in the process of forming the positive electrode active material, for example.

It is preferable that the positive electrode active material of one embodiment of the present invention include an addition element X, and phosphorus be used as the addition element X The positive electrode active material of one embodiment of the present invention further preferably includes a compound including phosphorus and oxygen.

When the positive electrode active material of one embodiment of the present invention includes a compound including the addition element X, a short circuit is less likely to occur while the high-voltage charged state is maintained in some cases.

When the positive electrode active material of one embodiment of the present invention contains phosphorus as the addition element X, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution can inhibit corrosion of a current collector and/or separation of the coating film in some cases or can inhibit a reduction in adhesion properties due to gelling and/or insolubilization of PVDF in some cases.

When containing magnesium in addition to the addition element X, the positive electrode active material of one embodiment of the present invention is extremely stable in the high-voltage charged state. When the addition element X is phosphorus, the number of phosphorus atoms is preferably 1% or more and 20% or less, further preferably 2% or more and 10% or less, still further preferably 3% or more and 8% or less of the number of cobalt atoms. In addition, the number of magnesium atoms is preferably 0.1% or more and 10% or less, further preferably 0.5% or more and 5% or less, still further preferably 0.7% or more and 4% or less of the number of cobalt atoms. The phosphorus concentration and the magnesium concentration described here may each be a value obtained by element analysis on the entire particle of the positive electrode active material using ICP-MS or the like, or may be a value based on the ratio of the source materials mixed in the process of forming the positive electrode active material, for example.

In the case where the positive electrode active material has a crack, phosphorus, more specifically, a compound containing phosphorus and oxygen, in the inner portion of the crack may inhibit crack development, for example.

As apparent from oxygen atoms indicated by arrows in FIG. 14, the symmetry of the oxygen atoms in the O3 type crystal structure is slightly different from that in the O3′ type crystal structure. Specifically, while the oxygen atoms in the O3 crystal structure are aligned along the (−1 0 2) plane shown by the dotted line, the oxygen atoms in the O3′ crystal structure are not strictly aligned along the (−1 0 2) plane shown by the dotted line. This is because an increase of tetravalent cobalt with a reduction of lithium expands the Jahn-Teller distortion and causes a distortion of the octahedral structure of CoO₆. Another cause is that repulsion between oxygens in a CoO₂ layer becomes stronger with the reduction of lithium.

Magnesium is preferably distributed in the whole particle of the positive electrode active material 904 of one embodiment of the present invention, and further preferably, the magnesium concentration in the surface portion of the particle is higher than the average in the whole particle. For example, the magnesium concentration in the surface portion of the particle that is measured by XPS or the like is preferably higher than the average magnesium concentration in the whole particle measured by ICP-MS or the like.

In the case where the positive electrode active material 904 of one embodiment of the present invention contains an element other than cobalt, for example, one or more metals selected from nickel, aluminum, manganese, iron, and chromium, the concentration of the metal in the surface portion of the particle is preferably higher than the average concentration of the metal in the whole particle. For example, the concentration of the element other than cobalt in the surface portion of the particle measured by XPS or the like is preferably higher than the average concentration of the element in the whole particle measured by ICP-MS or the like.

The surface of the particle is a kind of crystal defects and lithium is extracted from the surface during charging; thus, the lithium concentration in the surface of the particle tends to be lower than that inside the particle. Therefore, the surface of the particle tends to be unstable and its crystal structure is likely to break. The higher the magnesium concentration in the surface portion is, the more effectively the change in the crystal structure can be inhibited. In addition, when a magnesium concentration in the surface portion is high, it is expected that the corrosion resistance to hydrofluoric acid generated by the decomposition of the electrolyte solution is improved.

In addition, the concentration of halogen such as fluorine in the surface portion of the positive electrode active material 904 of one embodiment of the present invention is preferably higher than the average concentration of halogen such as fluorine in the entire particle. When halogen exists in the surface portion that is a region in contact with an electrolyte solution, the corrosion resistance to hydrofluoric acid can be effectively improved.

In this manner, the surface portion of the positive electrode active material 904 of one embodiment of the present invention preferably has the higher concentrations of the addition elements such as magnesium and fluorine than those in the inner portion and a composition different from that in the inner portion. In addition, the composition preferably has a crystal structure stable at normal temperature. Thus, the surface portion may have a crystal structure different from that of the inner portion. For example, at least part of the surface portion of the positive electrode active material 904 of one embodiment of the present invention may have a rock-salt crystal structure. Furthermore, in the case where the surface portion and the inner portion have different crystal structures, the orientations of crystals in the surface portion and the inner portion are preferably substantially aligned.

Anions of a layered rock-salt crystal and anions of a rock-salt crystal have a cubic close-packed structure (face-centered cubic lattice structure). Anions of an O3′ type crystal are also presumed to have a cubic close-packed structure. When these structures are in contact, there is a crystal plane at which orientations of cubic close-packed structures composed of anions are aligned. Note that the space groups of the layered rock-salt crystal and the O3′ type crystal are R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned is sometimes referred to as a state where crystal orientations are substantially aligned.

Whether the crystal orientations in two regions are substantially aligned with each other can be judged from a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, preferably less than or equal to 2.5° is observed from a TEM image or the like. Note that in a TEM image and the like, a light element typified by oxygen or fluorine cannot be clearly observed in some cases; in such a case, alignment of orientations can be judged by arrangement of metal elements.

Only with the structure where the surface portion includes only MgO or MgO and CoO(II) forms a solid solution, it is difficult to insert and extract lithium. Thus, the surface portion should contain at least cobalt, and further contain lithium in the discharged state to have a path through which lithium is inserted and extracted. In addition, the concentration of cobalt is preferably higher than that of magnesium.

The addition element X is preferably positioned on the surface portion of the particle in the positive electrode active material 904 of one embodiment of the present invention. For example, the positive electrode active material 904 of one embodiment of the present invention may be covered with a coating film containing the addition element X

### <<Grain Boundary>>

The addition element X or halogen contained in the positive electrode active material 904 of one embodiment of the present invention may randomly and slightly exist in the inner portion, but part of the element is further preferably segregated at a grain boundary.

In other words, the concentration of the addition element X in the grain boundary and its vicinity of the positive electrode active material 904 of one embodiment of the present invention is preferably higher than that in the other regions in the inner portion.

Like the particle surface, the crystal grain boundary is also a plane defect. Thus, the crystal grain boundary tends to be unstable and its crystal structure easily starts to change. Therefore, the higher the concentration of the addition element Xin the crystal grain boundary and its vicinity is, the more effectively the change in the crystal structure can be inhibited.

In the case where the concentration of the addition element X is high in the grain boundary and its vicinity, even when a crack is generated along the grain boundary of the particle of the positive electrode active material 904 of one embodiment of the present invention, the concentration of the addition element Xis increased in the vicinity of the surface generated by the crack. Thus, the positive electrode active material after the cracks are generated can also have increased corrosion resistance to hydrofluoric acid.

Note that in this specification and the like, the vicinity of the grain boundary refers to a region of approximately 10 nm from the grain boundary.

### <Particle Diameter>

A too large particle diameter of the positive electrode active material 904 of one embodiment of the present invention causes problems such as difficulty in lithium diffusion and too much surface roughness of an active material layer in coating to a current collector. By contrast, a too small particle diameter causes problems such as difficulty in carrying the active material layer in coating to the current collector and overreaction with an electrolyte solution. Therefore, an average particle diameter (D50, also referred to as median diameter) is preferably more than or equal to 1 μm and less than or equal to 100 μm, further preferably more than or equal to 2 μm and less than or equal to 40 μm, still further preferably more than or equal to 5 μm and less than or equal to 30 μm.

### <Analysis Method>

Whether or not a positive electrode active material has the O3′ crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described so far, the positive electrode active material 904 of one embodiment of the present invention has a feature of a small crystal structure change between the high-voltage charged state and the discharged state. A material where 50 wt % or more of the crystal structure largely changes between the high-voltage charged state and the discharged state is not preferable because the material cannot withstand the high-voltage charging and discharging. In addition, it should be noted that an objective crystal structure is not obtained in some cases only by addition of an addition element. For example, although having a lithium cobalt oxide containing magnesium and fluorine in common, the positive electrode active material has 60 wt % or more of the O3′ crystal structure in some cases, and has 50 wt % or more of the H1-3 type crystal structure in other cases, when charged with high voltage. Furthermore, at a predetermined voltage, the positive electrode active material has almost 100 wt % of the O3′ crystal structure, and with an increase in the predetermined voltage, the H1-3 type crystal structure is generated in some cases. Thus, analysis of the crystal structure, including XRD, is needed to determine whether or not the positive electrode active material is the positive electrode active material 904 of one embodiment of the present invention.

Note that a positive electrode active material in the high-voltage charged state or the discharged state sometimes causes a change in the crystal structure when exposed to air. For example, the O3′ crystal structure changes into the H1-3 type crystal structure in some cases. Thus, all samples are preferably handled in an inert atmosphere such as an argon atmosphere.

### Embodiment 4

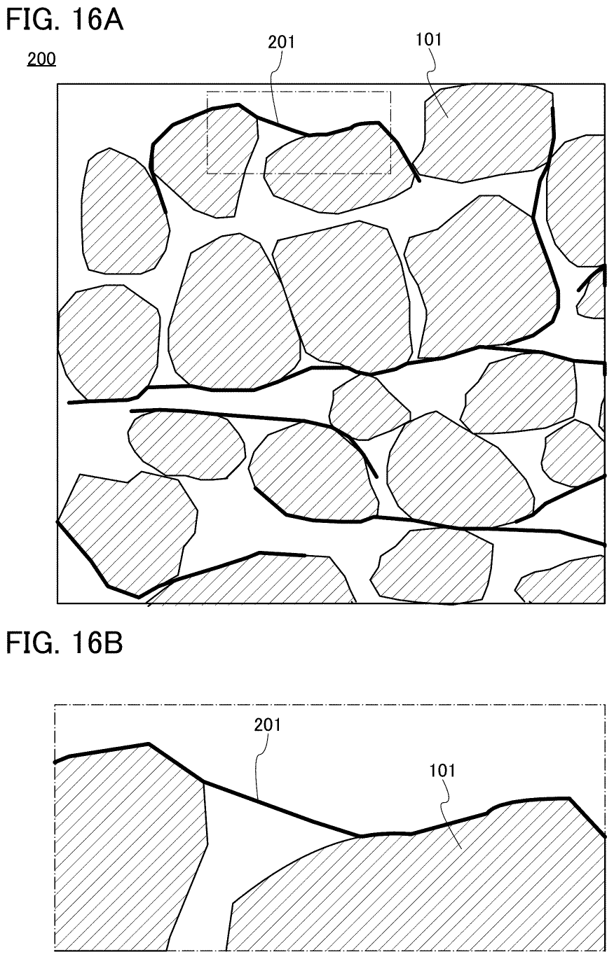

In this embodiment, an example of a secondary battery of one embodiment of the present invention is described with reference to FIG. 16 to FIG. 19.

### Structure Example 1 of Secondary Battery

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive additive and a binder. As the positive electrode active material, the positive electrode active material formed by the manufacturing method described in the foregoing embodiment is used. A cross-sectional structure example of an active material layer 200 using a graphene compound as a conductive additive is described below.

FIG. 16A is a longitudinal cross-sectional view of the active material layer 200. The active material layer 200 includes a particulate positive electrode active material 101, a graphene compound 201 serving as a conductive additive, and a binder (not illustrated).

The graphene compound 201 in this specification and the like refers to graphene, multilayer graphene, multi graphene, graphene oxide (GO), multilayer graphene oxide, multi graphene oxide, reduced graphene oxide (RGO), reduced multilayer graphene oxide, reduced multi graphene oxide, graphene quantum dots, and the like. A graphene compound contains carbon, has a plate-like shape, a sheet-like shape, or the like, and has a two-dimensional structure formed of carbon six-membered rings. The two-dimensional structure formed of the carbon six-membered ring may be referred to as a carbon sheet. A graphene compound may include a functional group. The graphene compound preferably has a bent shape. The graphene compound may be rounded like a carbon nanofiber. A graphene compound has excellent electrical characteristics of high conductivity and excellent physical properties of high flexibility and high mechanical strength in some cases.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a carbon six-membered ring. A graphene compound may also be referred to as a carbon sheet. The reduced graphene oxide can function as one sheet and may have a stacked-layer structure. The reduced graphene oxide preferably includes a portion where the carbon concentration is higher than 80 at % and the oxygen concentration is higher than or equal to 2 at % and lower than or equal to 15 at %. With such a carbon concentration and such an oxygen concentration, the reduced graphene oxide can function as a conductive additive with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive additive with high conductivity even with a small amount.

As illustrated in FIG. 16B, in the longitudinal cross section of the active material layer 200, the sheet-like graphene compounds 201 is substantially uniformly dispersed in the active material layer 200. The graphene compound 201 is schematically shown by a thick line in FIG. 16B but is actually a thin film having a thickness corresponding to the thickness of a single layer or a multi-layer of carbon molecules. The plurality of graphene compounds 201 are formed to partly coat or adhere to the surfaces of the plurality of particles of the positive electrode active material 101, so that the graphene compounds 201 make surface contact with the particles of the positive electrode active material 101. Therefore, the area where the active material and the conductive additive are in contact with each other can be increased.

Here, the plurality of graphene compounds are bonded to each other, thereby forming a net-like graphene compound sheet (hereinafter referred to as a graphene compound net or a graphene net). The graphene net covering the active material can function as a binder for bonding active materials. The amount of binder can thus be reduced, or the binder does not have to be used. This can increase the proportion of the active material in the electrode volume or the electrode weight. That is, the capacity of the secondary battery can be increased.

Here, it is preferable that graphene oxide be used as the graphene compounds 201 and mixed with an active material to form a layer to be the active material layer 200, and then reduction be performed. That is, the formed active material layer preferably contains reduced graphene oxide. When graphene oxide with extremely high dispersibility in a polar solvent is used for the formation of the graphene compounds 201, the graphene compounds 201 can be substantially uniformly dispersed in the active material layer 200. The solvent is removed by volatilization from a dispersion medium in which graphene oxide is uniformly dispersed, and the graphene oxide is reduced; hence, the graphene compounds 201 remaining in the active material layer 200 partly overlap with each other and are dispersed such that surface contact is made, thereby forming a three-dimensional conductive path. Note that graphene oxide can be reduced by heat treatment or with the use of a reducing agent, for example.

Unlike a conductive additive in the form of particles, such as acetylene black, which makes point contact with an active material, the graphene compound 201 is capable of making low-resistance surface contact; accordingly, the electrical conduction between the particulate positive electrode active materials 101 and the graphene compound 201 can be improved with a smaller amount of the graphene compound 201 than that of a normal conductive additive. This can increase the proportion of the positive electrode active material 101 in the active material layer 200. Thus, the discharge capacity of the secondary battery can be increased.

With a spray dry apparatus, a graphene compound serving as a conductive additive can be formed in advance as a coating film to cover the entire surface of the active material, and a conductive path can be formed between the active materials using the graphene compound.

### [Negative Electrode]

The negative electrode includes a negative electrode active material layer and a negative electrode current collector. The negative electrode active material layer may contain a negative electrode active material, a conductive additive, and a binder.

### [Negative Electrode Active Material]

As the negative electrode active material, for example, an alloy-based material or a carbon-based material can be used.

For the negative electrode active material, an element that enables charge-discharge reactions by an alloying and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon and especially, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge-discharge reactions by an alloying and a dealloying reaction with lithium and a compound containing the element, for example, may be referred to as an alloy-based material.

In this specification and the like, SiO refers, for example, to silicon monoxide. Note that SiO can alternatively be expressed as SiOx. Here, x preferably has an approximate value of 1. For example, x is preferably more than or equal to 0.2 and less than or equal to 1.5, and further preferably more than or equal to 0.3 and less than or equal to 1.2.

As the carbon-based material, graphite, graphitizing carbon (soft carbon), non-graphitizing carbon (hard carbon), carbon nanotube, graphene, carbon black, and the like may be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it is relatively easy to have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into graphite (when a lithium-graphite intercalation compound is formed). For this reason, a lithium-ion secondary battery can have a high operating voltage. In addition, graphite is preferable because of its advantages such as a relatively high capacity per unit volume, relatively small volume expansion, low cost, and higher level of safety than that of a lithium metal.

Alternatively, for the negative electrode active material, oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charging and discharging capacity (900 mAh/g and 1890 mAh/cm³).

A composite nitride of lithium and a transition metal is preferably used, in which case the negative electrode active material contains lithium ions and thus can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### [Negative Electrode Current Collector]

For the negative electrode current collector, a material similar to that of the positive electrode current collector can be used. Note that a material that is not alloyed with carrier ions such as lithium is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are less likely to burn and volatize as the solvent of the electrolyte solution can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolyte solution used for a secondary battery is preferably highly purified and contains small contents of dust particles or elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

An additive such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of a material to be added in the whole solvent is, for example, higher than or equal to 0.1 wt % and lower than or equal to 5 wt %.

Alternatively, a polymer gelled electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may be used. When the solid electrolyte is used, a separator and a spacer are not necessary. Furthermore, the battery can be entirely solidified; therefore, there is no possibility of liquid leakage and thus the safety is dramatically increased.

### [Separator]

The secondary battery preferably includes a separator. As the separator, for example, paper; nonwoven fabric; glass fiber; ceramics; or synthetic fiber containing nylon (polyamide), vinylon (polyvinyl alcohol-based fiber), polyester, acrylic, polyolefin, or polyurethane can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in charging and discharging at high voltage can be inhibited and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. An exterior body in the form of a film can also be used. As the film, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

### Structure Example 2 of Second Battery

A structure of a secondary battery using a solid electrolyte layer is described below as a structure example of a secondary battery. In this specification, not only secondary batteries using solid electrolytes but also secondary batteries using polymer gel electrolytes, slight amounts of electrolytes, or a combination of them are referred to as solid batteries.

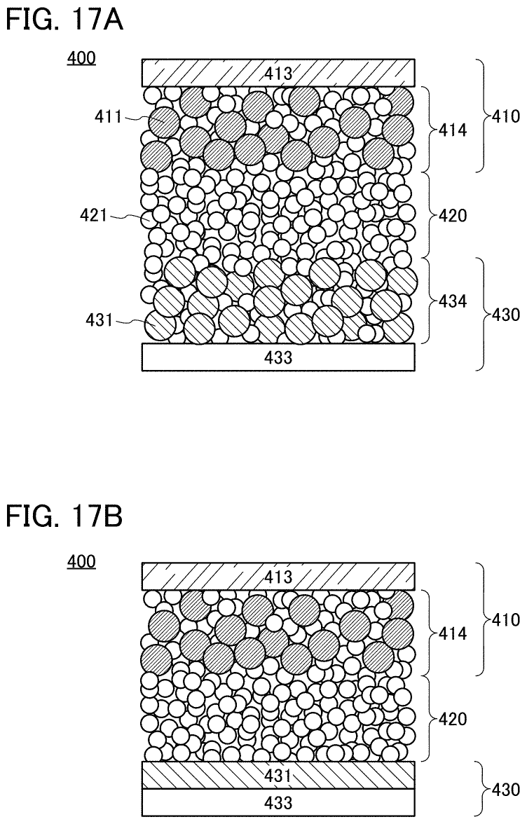

As illustrated in FIG. 17A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the manufacturing method described in the above embodiments is used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430, and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metal lithium is used for the negative electrode 430, it is possible that the negative electrode 430 does not include the solid electrolyte 421 as illustrated in FIG. 17B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolytes have advantages such as high conductivity in some of the materials, low-temperature synthesis, and ease of maintaining a conduction path after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1+X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) with a NASICON crystal structure (hereinafter LATP) is preferable because LATP contains aluminum and titanium, each of which is an element that can be contained in the positive electrode active material used for the secondary battery 400 of one embodiment of the present invention, and thus a synergistic effect of improving the cycle performance is expected. Moreover, higher productivity due to the reduction in the number of steps is expected. Note that in this specification and the like, a material with a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

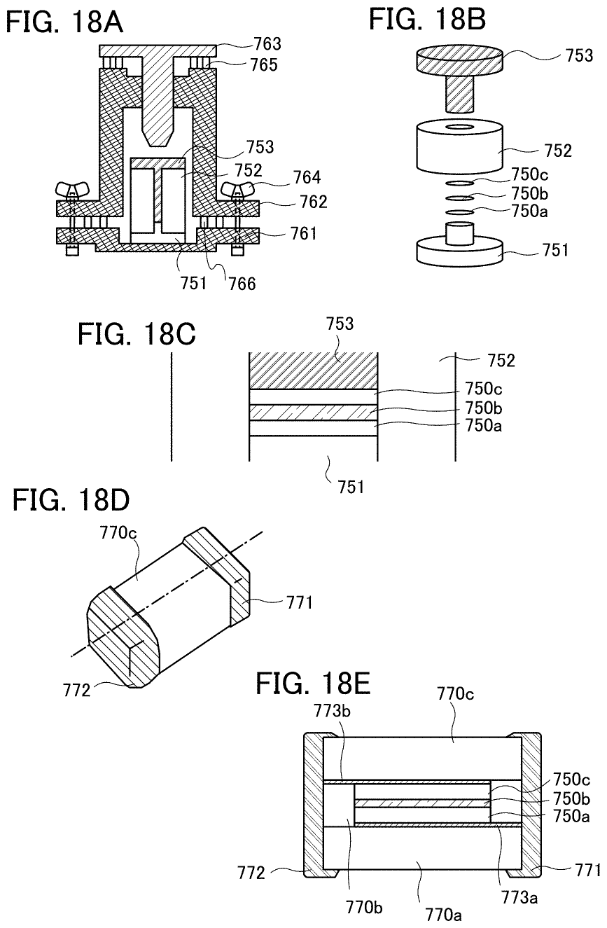

FIG. 18A, FIG. 18B, and FIG. 18C show an example of a cell for evaluating materials of an all-solid-state battery, for example.

FIG. 18A is a schematic cross-sectional view of an evaluation cell, the evaluation cell includes a lower component 761, an upper component 762, and a fixation screw and a butterfly nut 764 for fixing them, and by rotating a pressure screw 763, an electrode plate 753 is pressed to fix an evaluation material. The insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 18B is an enlarged perspective view of the evaluation material and its vicinity.

A stack of a positive electrode 750a, a solid electrolyte layer 750b, and a negative electrode 750c is exemplified as the evaluation material, and its cross section is shown in FIG. 18C. Note that the same portions in FIG. 18A, FIG. 18B, and FIG. 18C are denoted by the same reference numerals.

The electrode plate 751 and the lower component 761 that are electrically connected to the positive electrode 750a can be said to correspond to a positive electrode terminal. The electrode plate 753 and the upper component 762 that are electrically connected to the negative electrode 750c can be said to correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. Sealing of the exterior body is preferably performed in a closed atmosphere, for example, in a glove box, in which outside air is blocked.

FIG. 18D is a perspective view of a secondary battery of one embodiment of the present invention that has an exterior body and a shape different from those in FIG. 18A, FIG. 18B, and FIG. 18C. The secondary battery in FIG. 18D includes external electrodes 771 and 772 and is sealed with an exterior body including a plurality of package components.

FIG. 18E shows an example of a cross section along the dashed-dotted line in FIG. 18D. A stacked body including the positive electrode 750a, the solid electrolyte layer 750b, and the negative electrode 750c is surrounded and sealed by a package component 770a in which an electrode layer 773a is provided on a flat plate, a frame-like package component 770b, and a package component 770c in which an electrode layer 773b is provided on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with the other embodiments.

### Embodiment 5

In this embodiment, examples of the shape of a secondary battery using, as a positive electrode, the positive electrode active material formed by the forming method described in the above embodiment are described. For the materials used for the secondary battery described in this embodiment, the description of the above embodiment can be referred to.

### [Coin-Type Secondary Battery]

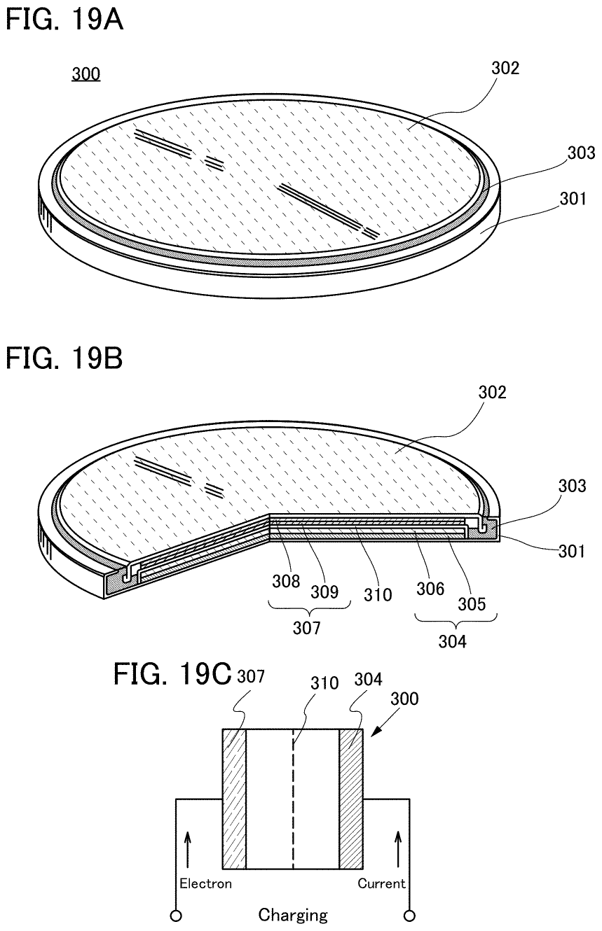

An example of a coin-type secondary battery is described. FIG. 19A is an external view of a coin-type (single-layer flat type) secondary battery, and FIG. 19B is a cross-sectional view thereof.

In a coin-type secondary battery 300, a positive electrode can 301 doubling as a positive electrode terminal and a negative electrode can 302 doubling as a negative electrode terminal are insulated and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably coated with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and a separator 310 are immersed in the electrolyte solution; as illustrated in FIG. 9B, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

When the positive electrode active material particle described in the above embodiment is used in the positive electrode 304, the coin-type secondary battery 300 with little deterioration and high safety can be obtained.

Here, a current flow in charging a secondary battery is described with reference to FIG. 19C. When a secondary battery using lithium is regarded as a closed circuit, lithium ions transfer in the same direction as a current flows. Note that in a lithium-ion secondary battery, the anode and the cathode are interchanged in charging and discharging, and the oxidation reaction and the reduction reaction are interchanged; thus, an electrode with a high reaction potential is called the positive electrode and an electrode with a low reaction potential is called the negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of terms such as anode and cathode related to oxidation reaction and reduction reaction might cause confusion because the anode and the cathode are reversed in charging and in discharging. Thus, the terms “anode” and “cathode” are not used in this specification. If the term anode or cathode is used, whether it is at the time of charging or discharging is noted and whether it corresponds to a positive electrode or a negative electrode is also noted.

Two terminals illustrated in FIG. 19C are connected to a charger, and the secondary battery 300 is charged. As the charge of the secondary battery 300 proceeds, a potential difference between electrodes increases.

### [Cylindrical Secondary Battery]

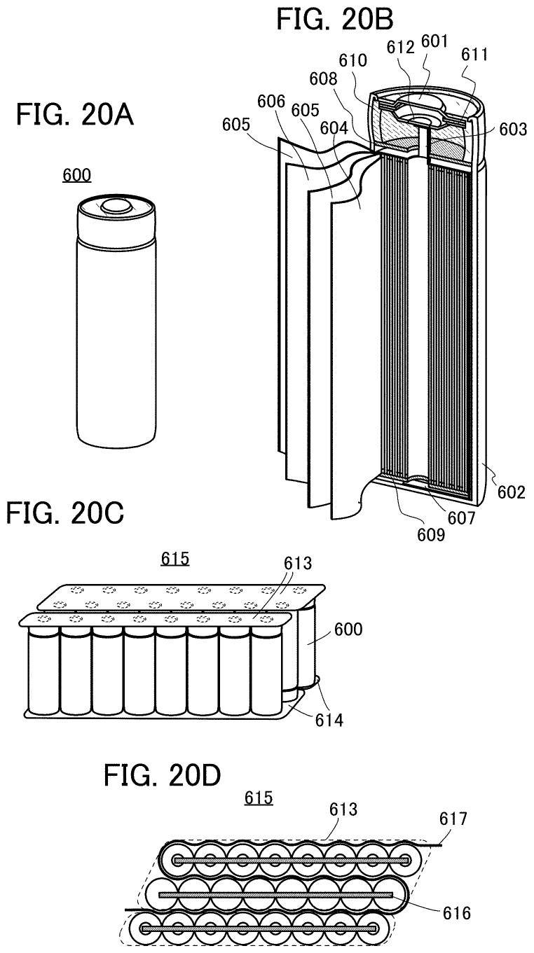

An example of a cylindrical secondary battery is described with reference to FIG. 20A to FIG. 20D. As illustrated in FIG. 20B, the cylindrical secondary battery 600 includes a positive electrode cap (battery lid) 601 on a top surface and a battery can (outer can) 602 on a side surface and a bottom surface. The positive electrode cap 601 and the battery can (outer can) 602 are insulated from each other by a gasket (insulating packing) 610.

FIG. 20B is a schematic cross-sectional view of a cylindrical secondary battery. Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel or aluminum, for example, in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

As illustrated in FIG. 20C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 20D is a top view of the module 615. The conductive plate 613 is shown by a dotted line for clarity of the drawing. As illustrated in FIG. 20D, the module 615 may include a conductive wire 616 electrically connecting the plurality of secondary batteries 600 with each other. The conductive plate can be provided over the conductive wire 616 to overlap the conductive wire 616. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature.

When the positive electrode active material formed by the forming method described in the above embodiment is used in the positive electrode 604, the cylindrical secondary battery 600 with little deterioration and high safety can be obtained.

### Structure Examples of Secondary Battery

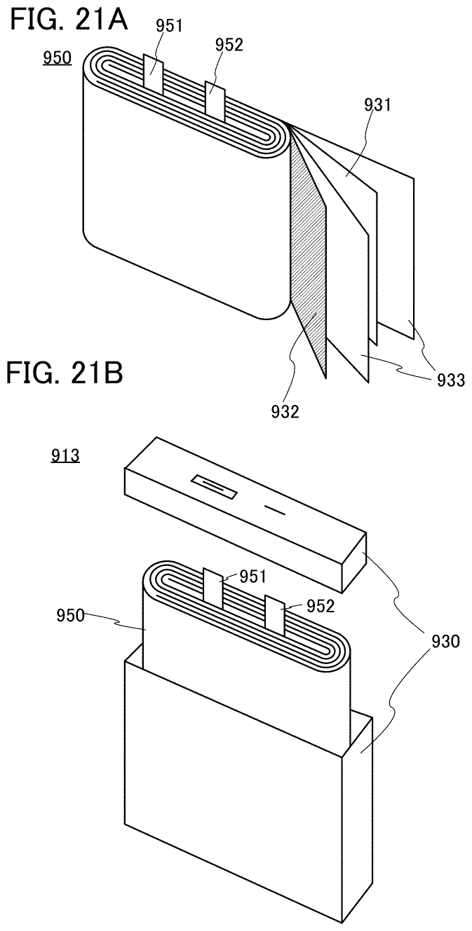

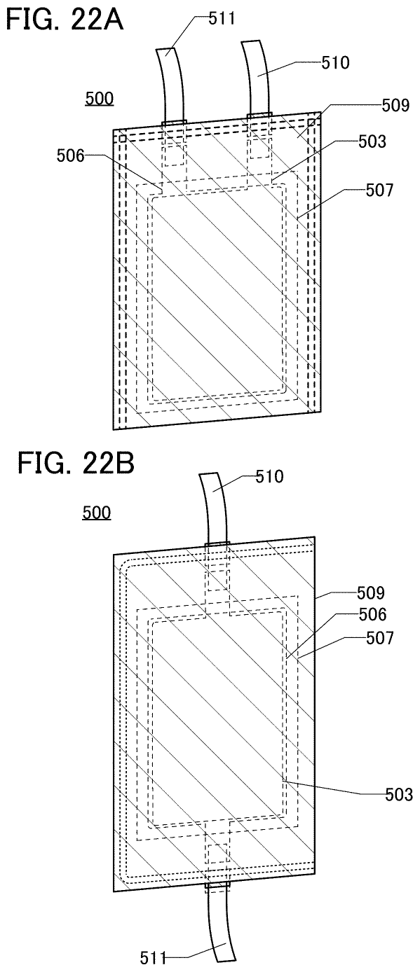

Other structure examples of secondary batteries are described with reference to FIG. 21 and FIG. 22.

FIG. 21A illustrates a structure of a wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks of the negative electrode 931, the positive electrode 932, and the separator 933 may be further overlaid.

The secondary battery 913 illustrated in FIG. 21B includes a wound body 950 provided with the terminal 951 and the terminal 952 inside a housing 930. The wound body 950 is immersed in an electrolyte solution inside the housing 930. The terminal 952 is in contact with the housing 930. The terminal 951 is not in contact with the housing 930 with user of an insulator or the like. Note that in FIG. 21B, the housing 930 that has been divided is illustrated for convenience; however, in reality, the wound body 950 is covered with the housing 930, and the terminal 951 and the terminal 952 extend to the outside of the housing 930. For the housing 930, a metal material (e.g., aluminum) or a resin material can be used.

### [Laminated Secondary Battery>

Next, an example of a laminated secondary battery is described with reference to FIG. 22A and FIG. 22B.

FIG. 22A illustrates an example of an external view of a laminated secondary battery 500. FIG. 22B illustrates another example of an external view of the laminated secondary battery 500.

In FIG. 22A and FIG. 22B, the positive electrode 503, the negative electrode 506, the separator 507, the exterior body 509, a positive electrode lead electrode 510, and a negative electrode lead electrode 511 are included.

The laminated secondary battery 500 includes a wound body or a plurality of positive electrodes 503, separators 507, and negative electrodes 506 that are each strip-shaped.

The wound body includes the negative electrode 506, the positive electrode 503, and the separator 507. The wound body is, like the wound body illustrated in FIG. 21A, obtained by winding a sheet of a stack in which the negative electrode 506 overlaps with the positive electrode 503 with the separator 507 provided therebetween.

The second battery may include the plurality of positive electrodes 503, separators 507, and negative electrodes 506 that are each strip-shaped in a space formed by a film serving as the exterior body 509.

A manufacturing method of the secondary battery including the plurality of positive electrodes 503, separators 507, and negative electrodes 506 that are each strip-shaped is described below.

First, the negative electrodes 506, the separators 507, and the positive electrodes 503 are stacked. This embodiment describes an example using five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrodes 506, the separators 507, and the positive electrodes 503 are placed over the exterior body 509.

As the exterior body 509, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The exterior body 509 is folded to interpose the stack therebetween. Then, the outer edges of the exterior body 509 are bonded to each other. The bonding can be performed by thermocompression, for example. In this bonding, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert gas atmosphere. Lastly, the inlet is sealed by bonding. In the above manner, the laminated secondary battery 500 can be fabricated.

When the positive electrode active material particle described in the above embodiment is used in the positive electrode 503, the secondary battery 500 with little deterioration and high safety can be obtained.

This embodiment can be freely combined with the other embodiments.

### Embodiment 6

In this embodiment, examples of electronic devices or a vehicle each using the secondary battery of one embodiment of the present invention will be described.

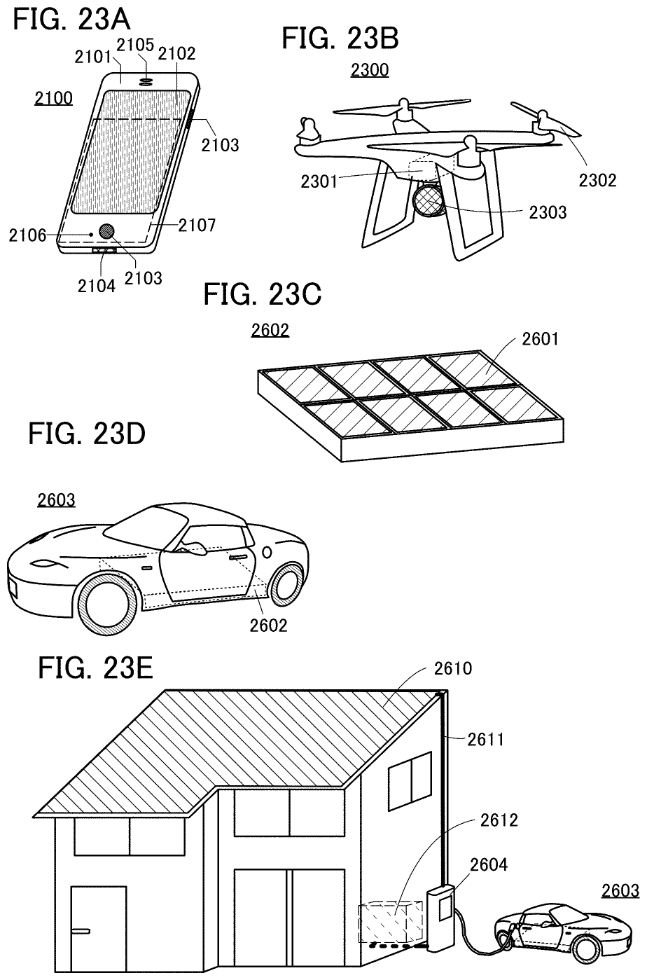

First, FIG. 23A to FIG. 23E show examples of electronic devices each including the secondary battery described in part of the above embodiments. Examples of electronic devices each including the bendable secondary battery include television devices (also referred to as televisions or television receivers), monitors for computers and the like, digital cameras, digital video cameras, digital photo frames, mobile phones (also referred to as cellular phones or mobile phone devices), portable game machines, portable information terminals, audio reproducing devices, and large game machines such as pachinko machines.

The secondary battery can also be used in moving vehicles, typically automobiles. Examples of the automobiles include next-generation clean energy vehicles such as hybrid vehicles (HEVs), electric vehicles (EVs), and plug-in hybrid vehicles (PHEVs), and the secondary battery can be used as one of the power sources provided for the automobiles. Furthermore, the moving object is not limited to an automobile. Examples of moving vehicles include a train, a monorail train, a ship, and a flying object (a helicopter, an unmanned aircraft (a drone), an airplane, and a rocket), electric vehicles, and electric motorcycles, and the secondary battery of one embodiment of the present invention can be used for the moving vehicles.

The secondary battery of this embodiment may be used in a ground-based charging apparatus provided for a house or a charging station provided in a commerce facility.

FIG. 23A illustrates an example of a mobile phone. A mobile phone 2100 includes a display portion 2102 installed in a housing 2101, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, by mutual communication between the mobile phone 2100 and a headset capable of wireless communication, hands-free calling can be performed.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 23B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention is preferable as a secondary battery mounted on the unmanned aircraft 2300 because it has a high level of safety and thus can be used safely for a long time over a long period.

Furthermore, as illustrated in FIG. 23C, a secondary battery 2602 including a plurality of secondary batteries 2601 of one embodiment of the present invention may be mounted on a hybrid electric vehicle (HEV), an electric vehicle (EV), a plug-in hybrid electric vehicle (PHEV), or another electronic device.

FIG. 23D illustrates an example of a vehicle including the secondary battery 2602. A vehicle 2603 is an electric vehicle that runs using an electric motor as a power source. Alternatively, the vehicle 2603 is a hybrid electric vehicle that can appropriately select an electric motor or an engine as a driving power source. The vehicle 2603 using the electric motor includes a plurality of ECUs (Electronic Control Units) and performs engine control by the ECUs. The ECU includes a microcomputer. The ECU is connected to a CAN (Controller Area Network) provided in the electric vehicle. The CAN is a type of a serial communication standard used as an in-vehicle LAN. The secondary battery of one embodiment of the present invention can be used to function as a power source of ECU and a vehicle with a high level of safety and a long cruising range can be achieved.

The secondary battery not only drives the electric motor (not illustrated) but also can supply electric power to a light-emitting device such as a headlight or a room light. Furthermore, the secondary battery can supply electric power to a display device and a semiconductor device included in the vehicle 2603, such as a speedometer, a tachometer, and a navigation system.

In the vehicle 2603, the secondary batteries included in the secondary battery 2602 can be charged by being supplied with electric power from external charging equipment by a plug-in system, a contactless power feeding system, or the like.

FIG. 23E illustrates a state in which the vehicle 2603 is supplied with electric power from ground-based charging equipment 2604 through a cable. In charging, a given method such as CHAdeMO (registered trademark) or Combined Charging System may be employed as a charging method, the standard of a connector, or the like as appropriate. For example, with a plug-in technique, the secondary battery 2602 incorporated in the vehicle 2603 can be charged by being supplied with electric power from the outside. Charging can be performed by converting AC power into DC power through a converter such as an ACDC converter. The charging equipment 2604 may be provided for a house as illustrated in FIG. 23E, or may be a charging station provided in a commercial facility.

Although not illustrated, the vehicle can include a power receiving device so as to be charged by being supplied with power from an above-ground power transmitting device in a contactless manner. In the case of the contactless power feeding system, by fitting a power transmitting device in a road or an exterior wall, charging can be performed not only when the vehicle is stopped but also when driven. In addition, this contactless power feeding system may be utilized to transmit and receive power between vehicles. Furthermore, a solar cell may be provided in the exterior of the vehicle to charge the secondary battery when the vehicle stops or moves. To supply power in such a contactless manner, an electromagnetic induction method or a magnetic resonance method can be used.

The house illustrated in FIG. 23E includes a power storage system 2612 including the secondary battery of one embodiment of the present invention and a solar panel 2610. The power storage system 2612 is electrically connected to the solar panel 2610 through a wiring 2611 or the like. The power storage system 2612 may be electrically connected to the ground-based charging equipment 2604. The power storage system 2612 can be charged with electric power generated by the solar panel 2610. The secondary battery 2602 included in the vehicle 2603 can be charged with the electric power stored in the power storage system 2612 through the charging equipment 2604.

The electric power stored in the power storage system 2612 can also be supplied to other electronic devices in the house. Thus, with the use of the power storage system 2612 of one embodiment of the present invention as an uninterruptible power source, electronic devices can be used even when electric power cannot be supplied from a commercial power source due to power failure or the like.

This embodiment can be implemented in appropriate combination with the other embodiments.

### Example 1

In this example, the characteristics of a positive electrode active material formed by the manufacturing method in Embodiment 1 were evaluated.

Samples manufactured in this example will be described with reference to the manufacturing method shown in FIG. 4.

C-10N (produced by NIPPON CHEMICAL INDUSTRIAL CO., LTD.) was used as the lithium oxide 901. As the fluoride 902, lithium fluoride and magnesium fluoride were used. In addition, aluminum hydroxide as an aluminum source and nickel hydroxide as a nickel source were mixed to the fluoride 902. When the number of cobalt atoms contained in the oxide 901 was 100, mixing was performed such that the number of molecules of lithium fluoride was 0.33, the number of molecules of magnesium fluoride was 1, the number of molecules of aluminum hydroxide was 0.5, and the number of molecules of nickel hydroxide was 0.5.

As in Step 13 to Step S15 in FIG. 4, the lithium oxide 901 and the fluoride 902 containing the aluminum source and the nickel source were mixed to obtain the mixture 903. The mixture 903 was placed in a container of alumina, a lid was put on the container, and then the container was placed in a muffle furnace.

Then, the mixture 903 was heated in a manner similar to that in Step S16. The heating conditions were 900° C., 20 hours, and an oxygen atmosphere. The thus formed positive electrode active material was used as Sample 1.

In addition, lithium cobalt oxide (C-10N) was prepared as Sample 2 (comparative example), to which the fluoride 902 or the like was not added and which was not heated.

As another comparative example, a nickel-cobalt-manganese oxide (NCM523 produced by MTI) in which the ratio of nickel to cobalt to manganese is Ni:Co:Mn=5:2:3 was used as a positive electrode active material to which the fluoride 902 or the like was not added and which was not heated. This was Sample 3.

Table 1 shows the fabrication conditions of Sample 1, Sample 2, and Sample 3.

TABLE 1

| | Mixture 903 | Fluroride 902 etc. | Heating |
|---|---|---|---|
| Sample 1 | LiCoO₂ 100 | LiF 0.33 | 900° C., 20 h |
| | (C-10N) | MgF₂ 1 | |
| | | Al(OH)₃ 0.5 | |
| | | Ni(OH)₂ 0.5 | |
| Sample 2 | LiCo02 | — | — |
| (Comparative | (C-10N) | | |
| example) | | | |
| Sample 3 | NCM523 | — | — |
| (Comparative | (produced by | | |
| example) | MTI) | | |

Secondary batteries were formed using the positive electrode active materials of Sample 1, Sample 2, and Sample 3. First, each of the positive electrode active materials of Samples 1 to 3, AB, and PVDF were mixed at a weight ratio of 95:3:2 to form a slurry, and the slurries were applied to aluminum current collectors. As a solvent of the slurry, NMP was used.

After the current collector was coated with the slurry, the solvent was volatilized. Then, pressure was applied at 210 kN/m, and then pressure was applied at 1467 kN/m. Through the above process, the positive electrode was obtained. The carried amount of the positive electrode was approximately 7 mg/cm². The densities of the positive electrode active material layer in which the positive electrode active material, AB, and PVDF were mixed in Sample 1 and Sample 3 were 3.987 g/cc and 3.415 g/cc, respectively.

Using the obtained positive electrodes, CR2032 type coin battery cells (a diameter of 20 mm, a height of 3.2 mm) were formed.

A lithium metal was used for a counter electrode.

As an electrolyte included in an electrolytic solution, 1 mol/L lithium hexafluorophosphate (LiPF₆) was used. As the electrolytic solution, a solution in which ethylene carbonate (EC) and diethyl carbonate (DEC) were mixed at a volume ratio of EC:DEC=3:7 and vinylene carbonate (VC) was added as an additive at 2 wt % was used.

As a separator, 25-μm-thick polypropylene was used.

A positive electrode can and a negative electrode can formed of stainless steel (SUS) were used.

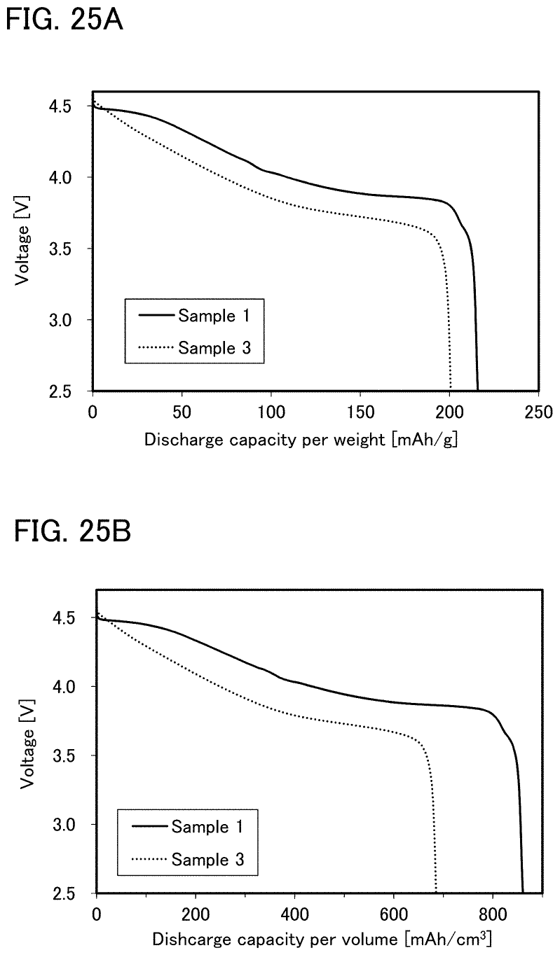

FIG. 25A and FIG. 25B show discharge characteristics of the secondary batteries using Sample 1 and Sample 3. FIG. 25A shows discharge capacity per weight, and FIG. 25B shows discharge capacity per volume of the positive electrode active material layer. The measurement was performed at 25° C. CC/CV charging (0.5 C, 4.6 V, 0.05 C cut) and CC discharging (0.5 C, 2.5 V cut) were performed, and a 10-minute break was taken before the next charging. Note that 1 C was set to 200 mA/g in this example and the like.

The discharge capacity of Sample 1 was 215.8 mAh/g per weight and 860.5 mAh/cm³ per volume. The discharge capacity of Sample 3 was 200.7 mAh/g per weight and 685.2 mAh/cm³ per volume.

The energy density per volume of Sample 1 was approximately 1.3 times that of Sample 3. Thus, the positive electrode active material of one embodiment of the present invention is proved to be a positive electrode active material having a high energy density. For example, when the positive electrode active material of one embodiment of the present invention is used for batteries for electric vehicles (EVs), the number of batteries (batteries connected in serial or in parallel) used as EV batteries can be reduced.

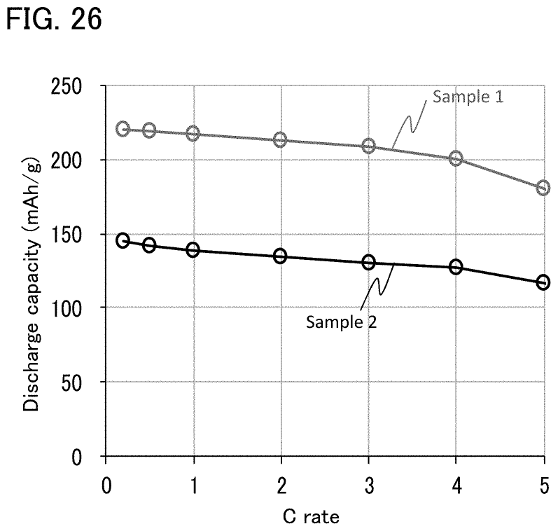

Next, rate characteristics of the secondary batteries using Sample 1 and Sample 2 were evaluated. FIG. 26 and Table 2 show rate characteristics at 0.2 C, 0.5 C, 1 C, 2 C, 3 C, 4 C, and 5 C.

The discharging rate refers to the relative ratio of current at the time of discharging to battery capacity and is expressed in a unit C. A current corresponding to 1 C in a battery with a rated capacity X (Ah) is X (A). The case where discharging is performed at a current of 2X (A) is rephrased as to perform discharging at 2 C, and the case where discharging is performed at a current of X/5 (A) is rephrased as to perform discharging at 0.2 C. The same applies to the charging rate; the case where charging is performed at a current of 2X (A) is rephrased as to perform charging at 2 C, and the case where charging is performed at a current of X/5 (A) is rephrased as to perform charging at 0.2 C.

Constant-current charging refers to, for example, a method of performing charging at a constant charging rate. Constant voltage charging refers to a charging method in which voltage is fixed when reaching the upper voltage limit, for example. Constant-current discharging refers to, for example, a method of performing discharging at a constant discharging rate.

The charging voltage of Sample 1 was 4.60 V. Sample 2 could not withstand charging at a high voltage; therefore, the charging voltage was set to 4.2 V at which Sample 2 could operate stably. The measurement was performed at 25° C. CC/CV charging (0.2 C, 4.20 V or 4.60 V, 0.02 Ccut) and CC discharging (0.2 C, 0.5 C, 1 C, 2 C, 3 C, 4 C, or 5 C, 2.5V) were performed, and a 10-minute break was taken before the next charging.

Table 2 shows each rate percentage (%) when 0.2 C is 100%.

TABLE 2

| C Rate | Sample 1 | Sample 2 |
|---|---|---|
| 0.2 | 100 | 100 |
| 0.5 | 99.3 | 98.3 |
| 1 | 98.3 | 96 |
| 2 | 96.5 | 93.3 |
| 3 | 94.5 | 90.3 |
| 4 | 90.8 | 87.7 |
| 5 | 81.9 | 81 |

As shown in FIG. 26 and Table 2, Sample 1 exhibited greatly favorable rate characteristics as compared with Sample 2. In addition, the decrease in discharge capacity in a high rate was small.

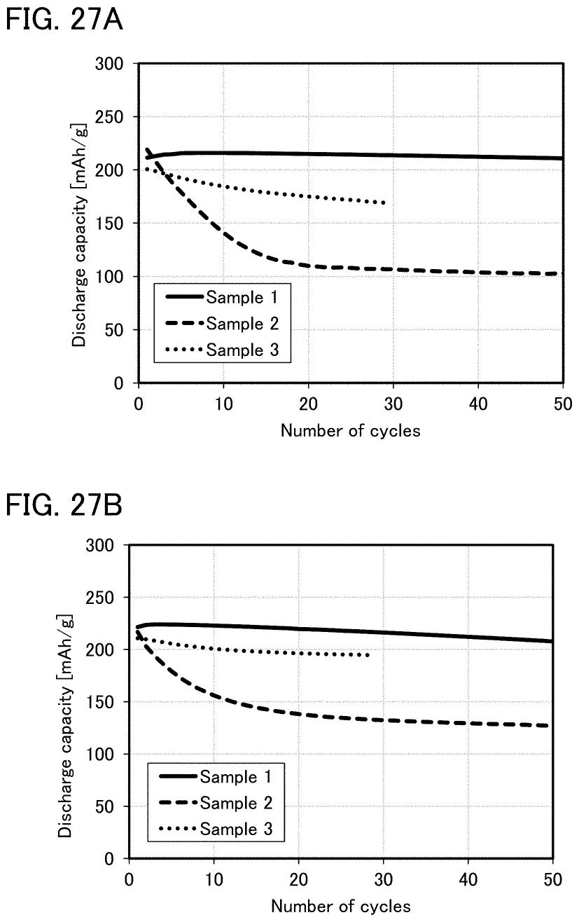

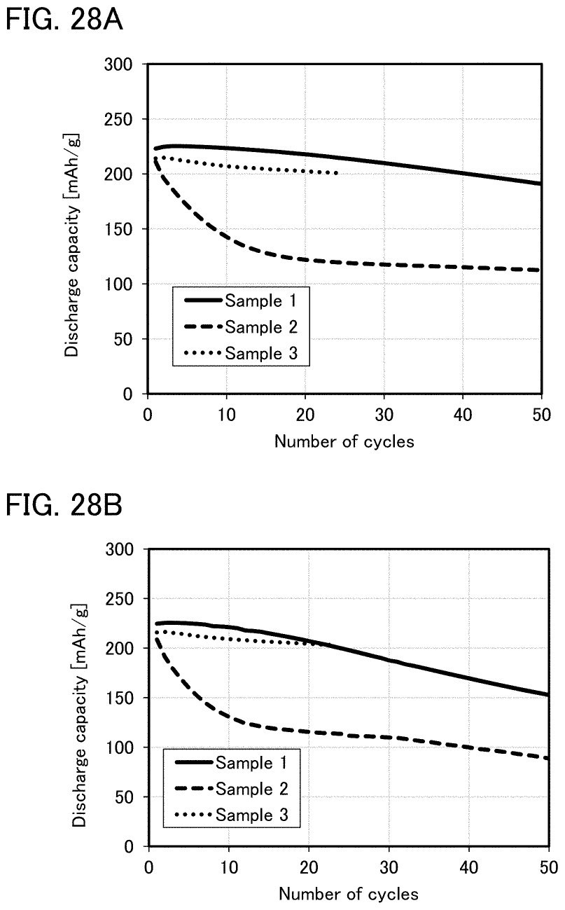

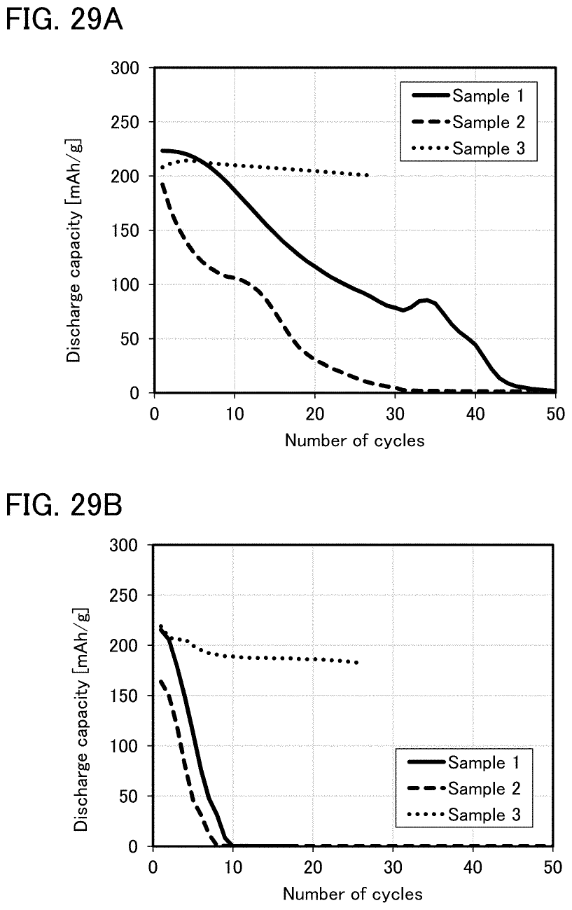

FIG. 27 to FIG. 29 show cycle characteristics of secondary batteries using Sample 1, Sample 2, and Sample 3, which were manufactured in a manner similar to the above, except that the carried amount of the positive electrode active material layer was approximately 8 mg/cm² and the density of the positive electrode active material layer was 3.8 g/cc or higher. FIG. 27A shows measurement at 25° C., FIG. 27B shows measurement at 45° C., FIG. 28A shows measurement at 50° C., FIG. 28B shows measurement at 55° C., FIG. 29A shows measurement at 65° C., and FIG. 29B shows measurement at 85° C. The other charging/discharging conditions were the same as those of the measurement of the discharge capacity.

Table 2 shows the capacity retention rate after 50 cycles of Sample 1 at each measurement temperature.

TABLE 3

| | Capacity |
|---|---|
| Measurement | retention rate |
| temperature | of Sample 1 |
| 25° C. | 98% |
| 45° C. | 93% |
| 50° C. | 85% |
| 55° C. | 68% |
| 65° C. | 0% |
| 85° C. | 0% |

As shown in FIG. 27A to FIG. 28A, Sample 1 of the positive electrode active material of one embodiment of the present invention has small deteriorations at 25° C. to 50° C. and exhibits greatly favorable high-temperature characteristics as compared with Sample 2, which is the lithium cobalt oxide not subjected to addition, heating, and the like. The high-temperature characteristics are equivalent to that of Sample 3, NCM523.

As shown in FIG. 28B to FIG. 29B, the cycle characteristics of Sample 3 are superior to those of Sample 1 at 55° C., 65° C., and 85° C. However, Sample 1 has superior characteristics to Sample 2.

As described above, Sample 1 that is the positive electrode active material of one embodiment of the present invention exhibited very excellent characteristics in the cycle test up to 45° C., which is needed for secondary batteries mainly for mobile electronic devices.

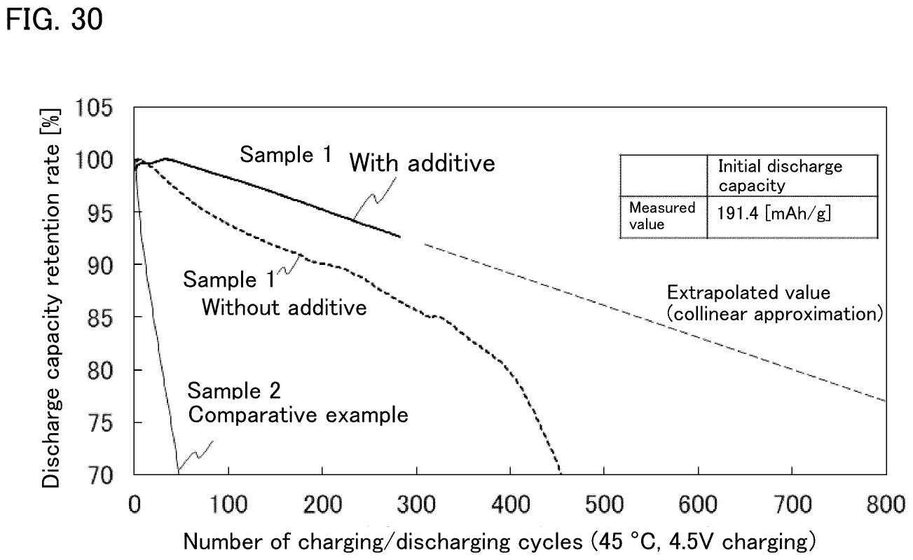

Then, laminated secondary batteries using the positive electrode active materials of Sample 1 and Sample 2 (comparative example) and synthetic graphite as negative electrodes were manufactured and their cycle characteristics were evaluated. FIG. 30 shows evaluation results. Note that actual measured values of “Sample 1, with additive”, “Sample 1, without additive”, and “Sample 2, (comparative example)” and an extrapolated value are shown in FIG. 30. Note that the extrapolated value is a value of extrapolation of collinear approximation from the actual measured value obtained up to 282 charging/discharging cycles of “Sample 1, with additive” and is shown by a broken line in FIG. 30.

As an electrolyte contained in an electrolytic solution, 1 mol/L of lithium hexafluorophosphate (LiPF₆) was used. As the electrolytic solution, a solution in which ethylene carbonate (EC) and diethyl carbonate (DEC) were mixed at EC:DEC=3:7 (volume ratio) was used. To the mixture, a 1 wt % LiBOB was added as an additive to form the secondary battery with an additive and LiBOB was not added to form the secondary battery without an additive.

The cycle characteristics were measured at 45° C. Charging was performed with CCCV (0.5 C, 4.5 V, termination current 0.2 C) and discharging was performed with CC (0.5 C, 3.0 V).

As shown in FIG. 30, Sample 1 with the additive exhibited extremely high cycle characteristics at 45° C.

The above results indicate that target secondary batteries as shown in Table 3 below can be achieved by using the positive electrode active material of one embodiment of the present invention.

TABLE 4

| Evaluation item | Target of half cell | Target of full cell |
|---|---|---|
| High- | 95%@45° C., 4.60 V, | 80%@45° C., 4.50 V, |
| temperature | 50 Cycle | 800 Cycle |
| cycle | | |
| Continuous | >80 hr@4.60 V, 60° C. | >1000 hr@4.50 V, 45° C. |
| charging | | |
| DSC | 1st peak > 140° C. | — |
| Initial discharge | 195~196 mAh/g | 195 mAh/g |
| capacity | @4.55 V | @4.50 V |
| Impedance | <70 mΩ@10% SOC | <55 mΩ@70% SOC |
| (initial) | | |
| Impedance | Ditto | — |
| (after cycles) | | |
| Green density | >4.30 g/cc (powder) | >4.25 g/cc (electrode) |
| (PPD) | | |

### REFERENCE NUMERALS

101: positive electrode active material, 102: space in heating furnace, 104: hot plate, 106: heater, 108: heat insulator, 116: container, 118: lid, 119: space, 120: heating furnace, 901 lithium oxide, 902: fluoride, 904: positive electrode active material

1. A manufacturing method of a positive electrode active material, comprising:
a first step of placing a container in which a lithium oxide and a fluoride are set in a heating furnace; and
a second step of heating the inside of the heating furnace in an atmosphere containing oxygen,
wherein a heating temperature of the second step is higher than or equal to 750° C. and lower than or equal to 950° C.

2. The manufacturing method of a positive electrode active material, according to claim 1,
wherein the heating temperature of the second step is higher than or equal to 775° C. and lower than or equal to 925° C.

3. The manufacturing method of a positive electrode active material, according to claim 1,
wherein the heating temperature of the second step is higher than or equal to 800° C. lower than or equal to 900° C.

4. The manufacturing method of a positive electrode active material, according to claim 1, further comprising:
a step of putting a lid on the container before the heating or during the heating,
wherein the fluoride is a lithium fluoride.

5. A manufacturing method of a positive electrode active material, comprising:
a first step of forming a lithium oxide by performing first heating on a lithium source and a transition metal source;
a second step of placing a container in which a lithium oxide and a fluoride are set in a heating furnace; and
a third step of performing second heating on the inside of the heating furnace in an atmosphere containing oxygen,
wherein the second heating is performed at higher than or equal to 750° C. lower than or equal to 950° C., and
wherein the first heating is performed at a higher temperature than the second heating.

6. The manufacturing method of a positive electrode active material, according to claim 1,
wherein the lithium oxide contains cobalt.

7. The manufacturing method of a positive electrode active material, according to of claim 1,
wherein the lithium oxide contains magnesium.

8. The manufacturing method of a positive electrode active material, according to claim 1,
wherein the lithium oxide contains nickel.

9. The manufacturing method of a positive electrode active material, according to claim 1,
wherein the lithium oxide contains aluminum.

10. The manufacturing method of a positive electrode active material, according to claim 1,
wherein the lithium oxide contains titanium.

11. The manufacturing method of a positive electrode active material, according to claim 1,
wherein the lithium oxide contains fluorine.

12. The manufacturing method of a positive electrode active material, according to claim 1,
wherein an oxygen concentration of the heating furnace is heightened before the second step.

13. A secondary battery comprising a positive electrode active material for a positive electrode,
wherein in a section cut toward a center of a particle of a lithium oxide containing fluorine, in observation with a scanning transmission electron microscope (STEM), at least part of the particle has a surface roughness less than 3 nm, when a particle surface unevenness information in the vicinity of the surface is quantified with measurement data.

14. The secondary battery according to claim 13, wherein the surface roughness is a root mean square surface roughness (RMS) in which a standard deviation is calculated.

15. The secondary battery according to claim 13, wherein the positive electrode active material has a surface roughness in at least 400 nm of a periphery of the particle.

16. A portable information terminal comprising the secondary battery according to claim 13.

17. A vehicle comprising the secondary battery according to claim 13.

18. The manufacturing method of a positive electrode active material, according to claim 5,
wherein the lithium oxide contains cobalt.

19. The manufacturing method of a positive electrode active material, according to claim 5,
wherein the lithium oxide contains magnesium.

20. The manufacturing method of a positive electrode active material, according to claim 5,
wherein the lithium oxide contains nickel.

21. The manufacturing method of a positive electrode active material, according to claim 5,
wherein the lithium oxide contains aluminum.

22. The manufacturing method of a positive electrode active material, according to claim 5,
wherein the lithium oxide contains titanium.

23. The manufacturing method of a positive electrode active material, according to claim 5,
wherein the lithium oxide contains fluorine.

24. The manufacturing method of a positive electrode active material, according to claim 5,
wherein an oxygen concentration of the heating furnace is heightened before the second step.
